(19) United States
(12) Patent Application Publication
(10) Pub. No.: US 2026/0011064 A1
(43) Pub. Date: Jan. 8, 2026

(54) IMAGE PROCESSING DEVICE, OPERATION METHOD OF IMAGE PROCESSING DEVICE, AND OPERATION PROGRAM OF IMAGE PROCESSING DEVICE

(71) Applicant: FUJIFILM Corporation, Tokyo (JP)

(72) Inventor: Kazuki OSHIMA, Saitama-shi (JP)

(73) Assignee: FUJIFILM Corporation, Tokyo (JP)

(21) Appl. No.: 19/324,074

(22) Filed: Sep. 9, 2025

Related U.S. Application Data
(63) Continuation of application No. PCT/JP2024/003326, filed on Feb. 1, 2024.

(30) Foreign Application Priority Data
Mar. 14, 2023 (JP) 2023-039566

(51) Int. Cl. G06T 13/40; G06T 19/20; G06V 40/16

(52) U.S. Cl. CPC G06T 13/40; G06T 19/20; G06V 40/168; G06V 40/172; G06T 2219/2016

(57) ABSTRACT

An image processing device includes a processor configured to acquire a plurality of images showing a plurality of different spaces including at least one virtual space in which an avatar of a user acts, and associate a plurality of faces that are shown in the images, that correspond to the same user, and that have different appearances in the plurality of spaces, with each other.

### CROSS-REFERENCE TO RELATED APPLICATIONS

This application is a continuation application of International Application No. PCT/JP2024/003326, filed Feb. 1, 2024, the disclosure of which is incorporated herein by reference in its entirety. Further, this application claims priority from Japanese Patent Application No. 2023-039566, filed on Mar. 14, 2023, the disclosure of which is incorporated herein by reference in its entirety.

### BACKGROUND

### 1. Technical Field

The technology of the present disclosure relates to an image processing device, an operation method of an image processing device, and an operation program of an image processing device.

### 2. Description of the Related Art

JP2017-056114A describes a video game processing program for causing a user terminal to realize a function of controlling progress of a video game in response to an operation of a user. The video game processing program described in JP2017-056114A causes the user terminal to realize an update function, a first display function, a second display function, and a storage function. The update function is a function of updating a position of a character that can be operated by each user on a virtual space based on a movement operation by one or a plurality of users. The first display function is a function of displaying a game screen corresponding to each user based on an update result obtained by the update function. The second display function is a function of displaying an imaging screen which is a game screen in which an object that is not the character of the user and that satisfies a predetermined condition in a case in which an imaging operation is performed executes a predetermined operation based on the imaging operation. The storage function is a function of storing at least a part of the imaging screen in a predetermined storage area based on a storage operation.

### SUMMARY

One embodiment according to the technology of the present disclosure provides an image processing device, an operation method of an image processing device, and an operation program of an image processing device capable of treating a plurality of faces, which appear in an image and correspond to the same user but have different appearances due to being in a plurality of different spaces, as faces corresponding to the same user.

The present disclosure relates to an image processing device comprising: a processor configured to: acquire a plurality of images showing a plurality of different spaces including at least one virtual space in which an avatar of a user acts; and associate a plurality of faces that are shown in the images, that correspond to the same user, and that have different appearances in the plurality of spaces, with each other.

It is preferable that the plurality of spaces include a plurality of the virtual spaces, and the plurality of faces having different appearances include a face of the avatar in each of the plurality of virtual spaces.

It is preferable that the plurality of spaces include the virtual space and a real space, and the plurality of faces having different appearances include a face of the avatar in the virtual space and a real face of the user in the real space.

It is preferable that the processor is configured to: acquire a list of face identification information of which a correspondence relationship with a feature value of a face is known; and perform the association by editing the list.

It is preferable that the processor is configured to: acquire a list of face identification information of which a correspondence relationship with a feature value of a face is known; derive a feature value of a face of which face identification information is unknown, from the image; and recognize which face identification information in the list corresponds to the face of which the face identification information is unknown, by collating the derived feature value with the feature value in the list.

It is preferable that the processor is configured to: receive designation of a target user; extract a specific image including an image showing a face of the target user from among the plurality of images based on a result of the recognition; and create a composite image based on the specific image.

It is preferable that there are a plurality of the target users, and the specific image includes an image showing the faces of the plurality of target users together.

It is preferable that the processor is configured to: assign a score to each of the plurality of images; and extract the specific image based on the scores.

It is preferable that the processor is configured to: assign a higher score to the image showing the face of the target user than an image not showing the face of the target user.

It is preferable that the plurality of spaces include a plurality of the virtual spaces, and the processor is configured to: dispose images showing a common event among a plurality of the specific images showing the plurality of virtual spaces, at adjacent positions in the composite image.

It is preferable that the plurality of spaces include a plurality of the virtual spaces, and the processor is configured to: in a case in which shown sizes of the avatars in the plurality of virtual spaces are different between a plurality of the specific images showing the plurality of virtual spaces, perform trimming on the specific images under a condition in which the shown sizes are equal to each other.

The present disclosure relates to an operation method of an image processing device, the operation method comprising: acquiring a plurality of images showing a plurality of different spaces including at least one virtual space in which an avatar of a user acts; and associating a plurality of faces that are shown in the images, that correspond to the same user, and that have different appearances in the plurality of spaces, with each other.

The present disclosure relates to an operation program of an image processing device for causing a computer to execute a process comprising: acquiring a plurality of images showing a plurality of different spaces including at least one virtual space in which an avatar of a user acts; and associating a plurality of faces that are shown in the images, that correspond to the same user, and that have different appearances in the plurality of spaces, with each other.

### BRIEF DESCRIPTION OF THE DRAWINGS

Exemplary embodiments according to the technique of the present disclosure will be described in detail based on the following figures, wherein:

FIG. 1 is a diagram showing a user terminal and an image management server;

FIG. 2 is a block diagram showing computers constituting the user terminal and the image management server;

FIG. 3 is a diagram showing images showing a real space, a first virtual space, and a second virtual space;

FIG. 4 is a block diagram showing processing units of a CPU of the user terminal;

FIG. 5 is a block diagram showing processing units of a CPU of the image management server;

FIG. 6 is a diagram showing data stored in an image DB;

FIG. 7 is a diagram showing the image and accessory information;

FIG. 8 is a diagram showing a face list;

FIG. 9 is a graph in which a space of a multi-dimensional feature value vector of a face feature value is represented by a two-dimensional space;

FIG. 10 is a diagram showing a detailed configuration of an editing unit;

FIG. 11 is a diagram showing processing of each of processing units of the image management server in a case in which an image storage request is transmitted from the user terminal;

FIG. 12 is a diagram showing a detailed configuration and processing of a face ID recognition unit;

FIG. 13 is a diagram showing a face editing screen;

FIG. 14 is a diagram showing processing of each of processing units of the image management server in a case in which a person integration request is transmitted from a user terminal;

FIG. 15 is a diagram showing processing of an association unit;

FIG. 16 is a diagram showing an album creation screen;

FIG. 17 is a diagram showing processing of each of processing units of the image management server in a case in which an album creation request is transmitted from the user terminal;

FIG. 18 is a diagram showing a detailed configuration and processing of an album creation unit;

FIG. 19 is a diagram showing an album display screen;

FIG. 20 is a diagram showing a case in which designation of a plurality of target users is received on the album creation screen;

FIG. 21 is a diagram showing the album display screen on which a photo album including an image showing faces of the plurality of target users together is displayed;

FIG. 22 is a flowchart showing processing of the image management server in a case in which the image storage request is received;

FIG. 23 is a flowchart showing processing of the image management server in a case in which the person integration request is received;

FIG. 24 is a flowchart showing processing of the image management server in a case in which the album creation request is received;

FIG. 25 is a diagram showing a detailed configuration and processing of an album creation unit, which includes an event determination unit, according to a second embodiment;

FIG. 26 is a diagram showing an album display screen on which a photo album showing images showing a common event are disposed at adjacent positions is displayed;

FIG. 27 is a diagram showing a detailed configuration and processing of an album creation unit, which includes a trimming unit, according to a third embodiment; and

FIG. 28 is a diagram showing a state in which trimming for aligning sizes of faces of avatars in the virtual spaces is performed.

### DETAILED DESCRIPTION

### First Embodiment

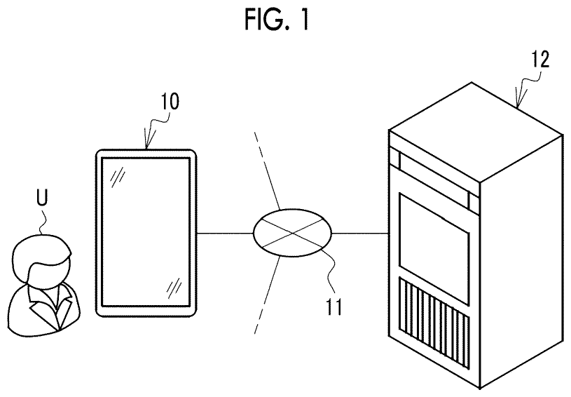

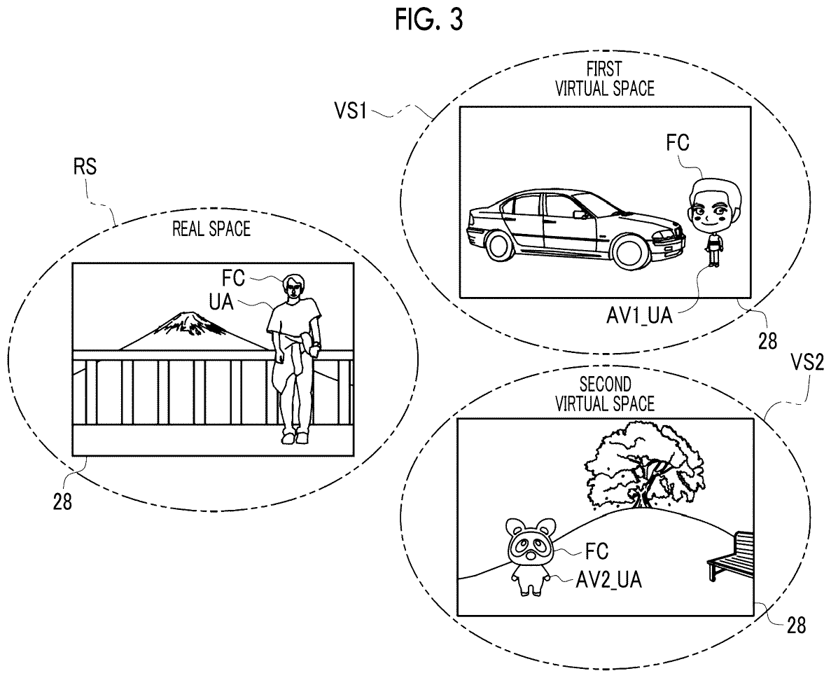

As an example, as shown in FIG. 1, a user U owns a user terminal 10. The user terminal 10 is a device having a camera function, an image reproduction display function, an image editing function, an image transmission/reception function, and the like. The camera function is a function of having an imaging element such as a complementary metal-oxide-semiconductor (CMOS) image sensor, and obtaining an image 28 (see FIG. 3) of a subject by forming an image of subject light, which is taken in from a lens, on the imaging element. Specifically, the user terminal 10 is a smartphone, a tablet terminal, a laptop personal computer, a desktop personal computer, or the like. The user U captures the image 28 by using the camera function or edits the image 28 to a personal preference by using the image editing function.

The user terminal 10 is connected to an image management server 12 via a network 11 such that the user terminal 10 and the image management server 12 can communicate with each other. The network 11 is, for example, a wide area network (WAN) such as the Internet or a public communication network. The user terminal 10 transmits (uploads) the image 28 to the image management server 12. In addition, the user terminal 10 receives (downloads) the image 28 from the image management server 12.

The image management server 12 is, for example, a server computer or a workstation, and is an example of an “image processing device” according to the technology of the present disclosure. A plurality of user terminals 10 of a plurality of users U are connected to the image management server 12 via the network 11.

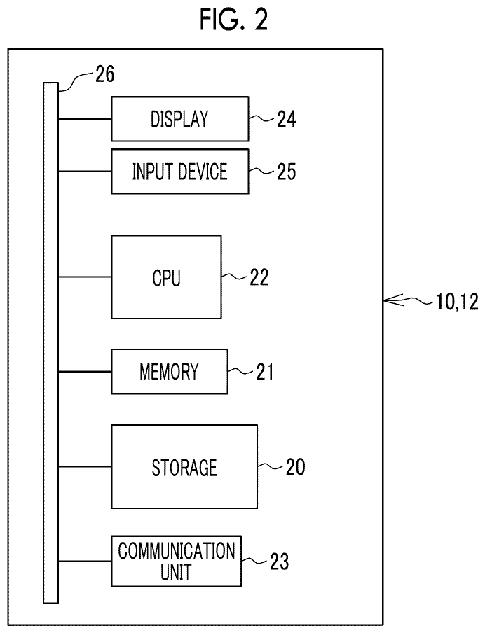

As shown in FIG. 2 as an example, computers constituting the user terminal 10 and the image management server 12 basically have the same configuration, and comprise a storage 20, a memory 21, a central processing unit (CPU) 22, a communication unit 23, a display 24, and an input device 25. These units are connected to each other through a busline 26.

The storage 20 is a hard disk drive that is built in the computers constituting the user terminal 10 and the image management server 12 or that is connected to the computers through a cable or a network. Alternatively, the storage 20 is a disk array provided with a plurality of hard disk drives mounted in series. A control program, such as an operating system, various application programs (hereinafter, abbreviated as AP), various data associated with these programs, and the like are stored in the storage 20. In addition, a solid state drive may be used instead of the hard disk drive.

The memory 21 is a work memory used by the CPU 22 to execute processing. The CPU 22 loads the program stored in the storage 20 into the memory 21, to execute processing in accordance with the program. As a result, the CPU 22 integrally controls the respective units of the computer. The CPU 22 is an example of a “processor” according to the technology of the present disclosure. In addition, the memory 21 may be built in the CPU 22.

The communication unit 23 is a network interface that performs control of transmitting various types of information via the network 11 and the like. The display 24 displays various screens. The various screens have an operation function using a graphical user interface (GUI). The computers constituting the user terminal 10 and the image management server 12 receive input of an operation instruction from the input device 25 through various screens. The input device 25 is, for example, a keyboard, a mouse, a touch panel, and a microphone for voice input.

In the following description, the respective units (the storage 20, the CPU 22, the display 24, and the input device 25) of the computer constituting the user terminal 10 are distinguished by adding a subscript “A” to the reference numerals thereof, and the respective units (the storage 20 and the CPU 22) of the computer constituting the image management server 12 are distinguished by adding a subscript “B” to the reference numerals thereof.

The user terminal 10 has a screen capture function in addition to the various functions. The screen capture function is a function of capturing (so-called screenshot) the image 28 of the screen displayed on the display 24A by performing a predetermined operation such as pressing a power button and a volume down button at the same time.

As shown in FIG. 3 as an example, a user UA who is one of the users U acts as a first avatar AV1_UA in a first virtual space VS1 and acts as a second avatar AV2_UA in a second virtual space VS2. The first virtual space VS1 and the second virtual space VS2 are three-dimensional computer graphics (CG) spaces that can be used by a computer, and are places in which various social activities such as studying, working, shopping, and playing are performed separately from a real space while communicating with other users. The first virtual space VS1 and the second virtual space VS2 are examples of a “virtual space” according to the technology of the present disclosure.

The user UA in a real space RS and the first avatar AV1_UA and the second avatar AV2_UA in the first virtual space VS1 and the second virtual space VS2 have different appearances. Therefore, a real face FC of the user UA in the real space RS and a face FC of the first avatar AV1_UA and a face FC of the second avatar AV2_UA in the first virtual space VS1 and the second virtual space VS2 also have different appearances.

The user UA obtains the image 28 in which the user UA is shown, by imaging the user UA by the camera function in the real space RS. In addition, the user UA can obtain the image 28 in which the first avatar AV1_UA and the second avatar AV2_UA are shown by imaging the screen with the screen capture function in the first virtual space VS1 and the second virtual space VS2.

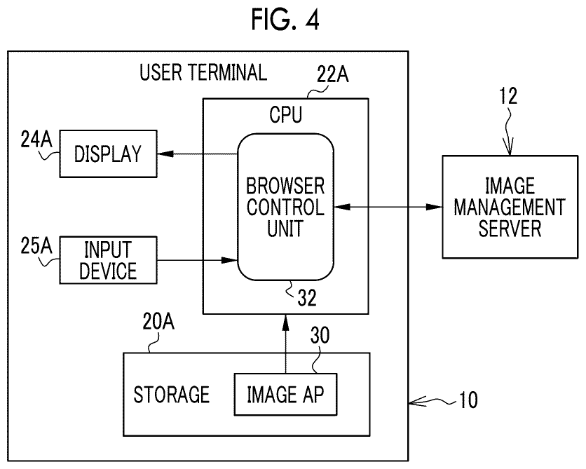

As shown in FIG. 4 as an example, an image AP 30 is stored in the storage 20A of the user terminal 10. The image AP 30 is installed in the user terminal 10 by the user U. The image AP 30 is an AP for reproducing and displaying or editing the image 28 on the user terminal 10. In a case in which the image AP 30 is activated, a CPU 22A of the user terminal 10 functions as a browser control unit 32 in cooperation with the memory 21 and the like. The browser control unit 32 controls the operation of the dedicated web browser of the image AP 30.

The browser control unit 32 generates various screens. The browser control unit 32 displays the generated various screens on the display 24A. Furthermore, the browser control unit 32 receives various operation instructions, which are input from the input device 25A by the user U, through various screens. The browser control unit 32 transmits various requests in accordance with the operation instructions to the image management server 12.

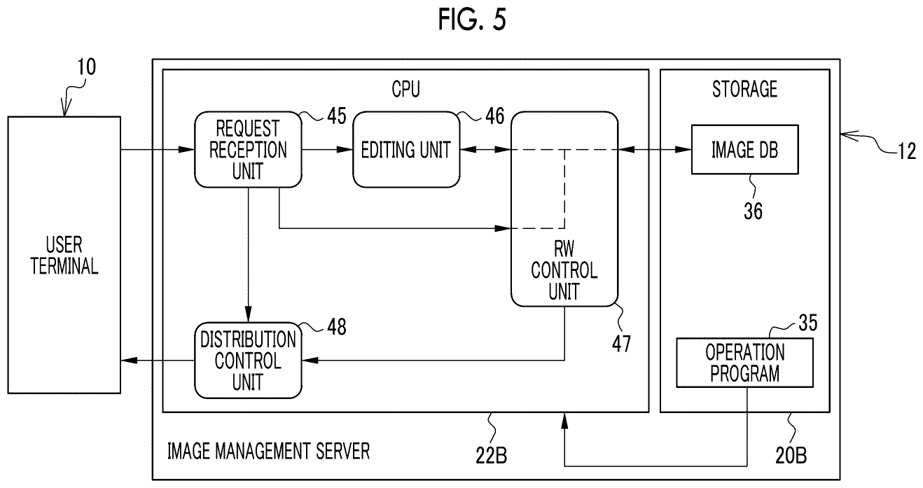

As shown in FIG. 5 as an example, an operation program 35 is stored in the storage 20B of the image management server 12. The operation program 35 is an AP for causing the computer constituting the image management server 12 to function as an “image processing device” according to the technology of the present disclosure. That is, the operation program 35 is an example of an “operation program of an image processing device” according to the technology of the present disclosure.

An image database (hereinafter, referred to as a DB) 36 and the like are also stored in the storage 20B. Although not shown in the drawing, the storage 20B stores a user identification data (ID) for uniquely identifying the user U, a password set by the user U, and a terminal ID for uniquely identifying the user terminal 10, as account information of the user U.

In a case in which the operation program 35 is activated, the CPU 22B of the image management server 12 functions as a request reception unit 45, an editing unit 46, a read-write (hereinafter, referred to as RW) control unit 47, and a distribution control unit 48 in cooperation with the memory 21 and the like.

The request reception unit 45 receives various requests from the user terminal 10. The request reception unit 45 outputs various requests to the editing unit 46 and/or the RW control unit 47 and the distribution control unit 48.

The editing unit 46 performs various types of editing processing. The editing unit 46 outputs results of various types of editing processing to the RW control unit 47.

The RW control unit 47 controls the storage of various types of data in the storage 20B and the read-out of various types of data from the storage 20B. In particular, the RW control unit 47 controls the storage of the image 28 in the image DB 36 and the read-out of the image 28 from the image DB 36. In addition, the RW control unit 47 controls the storage of the results of various types of editing processing from the editing unit 46 in the image DB 36. The distribution control unit 48 controls the distribution of various types of data to the user terminal 10.

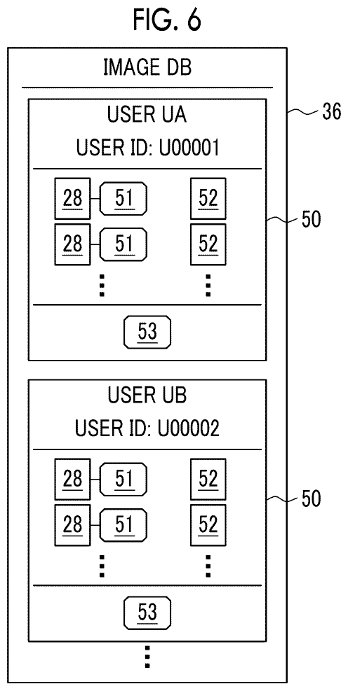

As shown in FIG. 6 as an example, the image DB 36 is provided with a storage area 50 for each user U, such as the user UA and a user UB. A user ID is registered in the storage area 50. In addition, although not shown, attribute information is registered in the storage area 50. The attribute information is information indicating an attribute of the user U literally, and includes a gender, an age, a family structure, and the like. The attribute information is acquired, for example, by causing the user U to answer a questionnaire in a case in which the user U installs the image AP 30 on the user terminal 10. It should be noted that the birthplace, current address, hobby, and the like of the user U may be included in the attribute information.

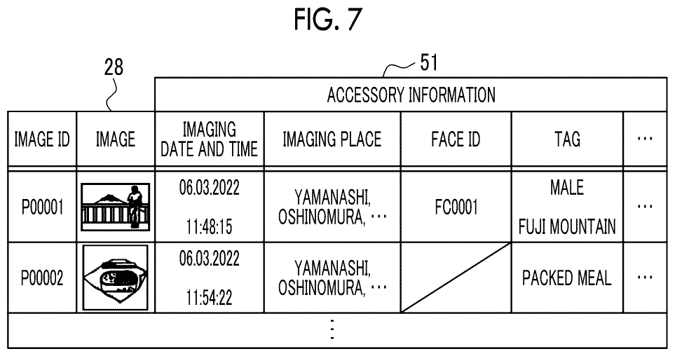

The image 28 and accessory information 51 of the image 28 are stored in the storage area 50. As shown in FIG. 7 as an example, the image 28 and the accessory information 51 are associated with each other by an image ID. The accessory information 51 includes a plurality of items such as an imaging date and time, an imaging place, a face ID, and a tag.

A date and time when the image 28 is captured with the camera function or the screen capture function of the user terminal 10 is registered as the imaging date and time. An address and/or a landmark name derived from latitude and longitude information obtained with a global positioning system (GPS) function of the user terminal 10 is registered as the imaging place. The face ID is information for uniquely identifying the face FC shown in the image 28. That is, the face ID is an example of “face identification information” according to the technology of the present disclosure. The face ID is not registered in the image 28 not showing the face FC. The tag is a word that briefly represents a subject shown in the image 28. The tag includes a tag manually input by the user U or a tag derived using a machine learning model for subject discrimination. It should be noted that, although not shown, the accessory information 51 also includes items such as an exposure value, an international organization for standardization (ISO) sensitivity, a shutter speed, a focal length, and the presence or absence of a flash.

In FIG. 6, a photo album 52 is also stored in the storage area 50. The photo album 52 is created by laying out (for example, laying out in the order of imaging date and time) a plurality of images 28 corresponding to a theme designated by the user U in a designated layout frame as appropriate. The photo album 52 is an example of a “composite image” according to the technology of the present disclosure. In addition, the photo album 52 is not stored in the storage area 50 of the user U who has not created the photo album 52.

In addition, a face list 53 is also stored in the storage area 50. The face list 53 is a list that covers information related to all the faces FC shown in the image 28. The face FC may be the real face FC of the user U or the face FC of the avatar AV. The face list 53 is an example of a “list of face identification information of which a correspondence relationship with a feature value of a face is known” according to the technology of the present disclosure.

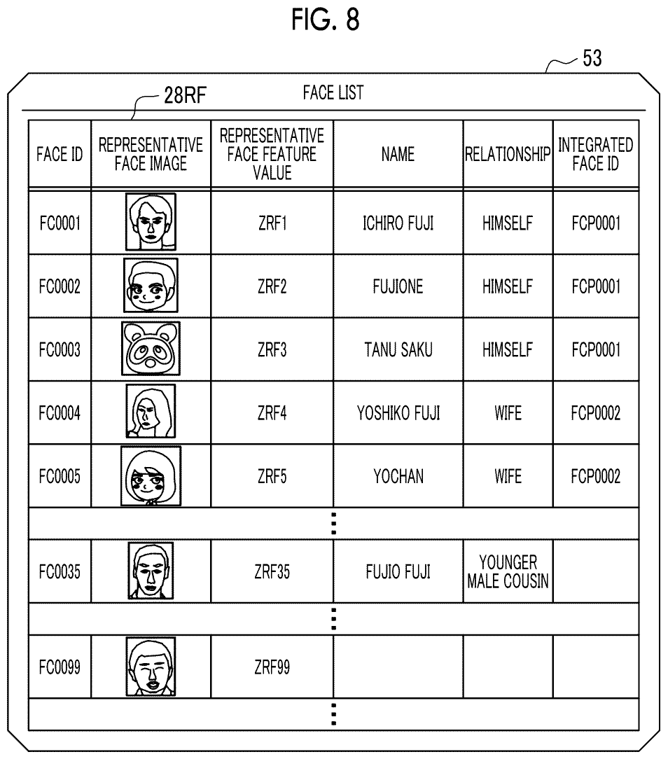

As shown in FIG. 8 as an example, at least a representative face image 28RF and a representative face feature value ZRF are registered in the face list 53 for each face ID. The representative face image 28RF is an enlarged image of the face FC shown in the image 28, and is an image representing the face FC represented by the face ID. The representative face image 28RF is generated, for example, by trimming a portion of the face FC from the image 28 selected by the user U from among the plurality of images 28 showing the face FC represented by the face ID. Alternatively, the representative face image 28RF is generated by trimming a portion of the face FC from the latest image 28 among the plurality of images 28 showing the face FC represented by the face ID.

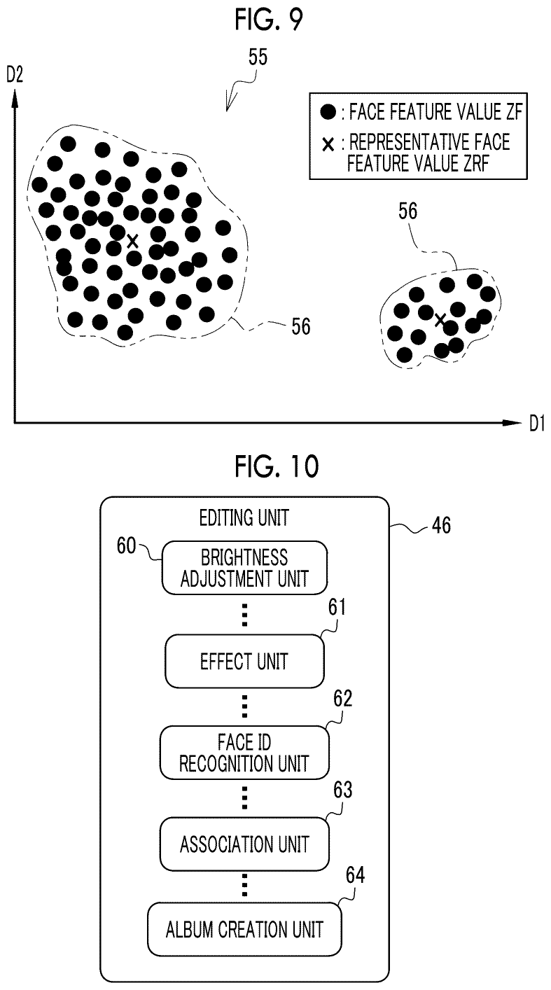

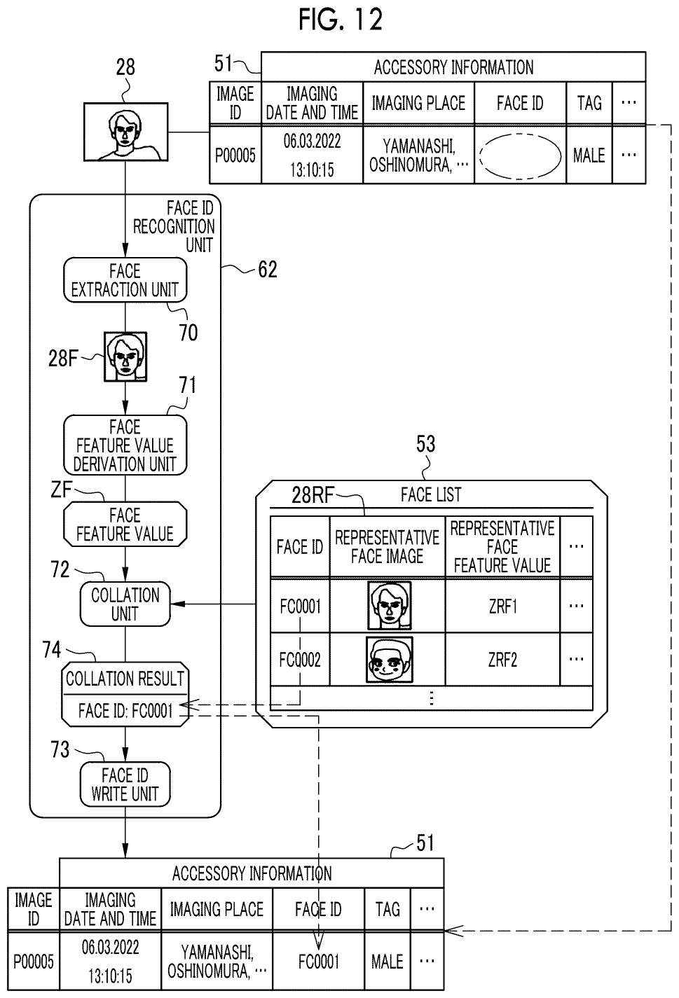

The representative face feature value ZRF is a representative value of a face feature value ZF (see FIG. 9) that characterizes the face FC represented by the face ID. There are a plurality of types of the face feature values ZF, and the face feature values ZF include, for example, a feature value indicating a distance between various feature points of the face FC, such as the inner canthus, the outer canthus, the medial eyebrow, the lateral eyebrow, the pupil, the nostril, and the mouth corner, and a shape of a polygonal region formed by connecting three or more feature points. In addition, the face feature value ZF may include a face image 28F (see FIG. 12), a representative value (an average value, a most frequent value, a maximum value, a minimum value, or the like) of the pixel values of the image obtained by filtering the face image 28F, a feature value obtained by inputting the face image 28F to a machine learning model such as an autoencoder, and the like. That is, the face feature value ZF can be said to be a multi-dimensional feature value vector. In FIG. 8, the representative face feature value of the face FC having a face ID of FC0001 is denoted by ZRF1, the representative face feature value of the face FC having a face ID of FC0002 is denoted by ZRF2, . . . , the representative face feature value of the face FC having a face ID of FC0099 is denoted by ZRF99, . . . , and the like, and the representative face feature values are distinguished by attaching the same numbers as the face IDs.

FIG. 9 is a graph in which a space 55 of the multi-dimensional feature value vector of the face feature value ZF (hereinafter, referred to as a feature value space) is represented by a two-dimensional space having a D1 axis and a D2 axis for convenience of description. In the feature value space 55, the face feature values ZF of the same face FC are distributed in a biased manner at one place in general, although there is a slight variation due to a difference in appearances, and form a cluster 56 as shown by a two-dot chain line enclosure. The cluster 56 is a group of one block that can be regarded as the distribution of the face feature values ZF of the face FC of the same person. The representative face feature value ZRF is a center point, an average point, or the like of the cluster 56.

In FIG. 8, the face list 53 also has items of a name, a relationship, and an integrated face ID. The real names of the user U and the acquaintance of the user U (family, relative, colleague of the company, friend, and the like) are registered as the names of the real faces FC of the user U and the acquaintance. Meanwhile, the name given to the avatar AV by the user U and the acquaintance in the virtual space VS is registered as the name of the face FC of the avatar AV. As the relationship, regardless of whether the face FC is the real face FC or the face FC of the avatar AV, the user U himself/herself is registered in a case of the user U himself/herself, the wife, the son, the daughter, and the like are registered in a case of the family of the user U, the cousin, the nephew, the niece, and the like are registered in a case of the relatives of the user U, and the colleague and the friend are registered in a case of the colleague and the friend of the user U. These names and relationships are registered manually by the user U.

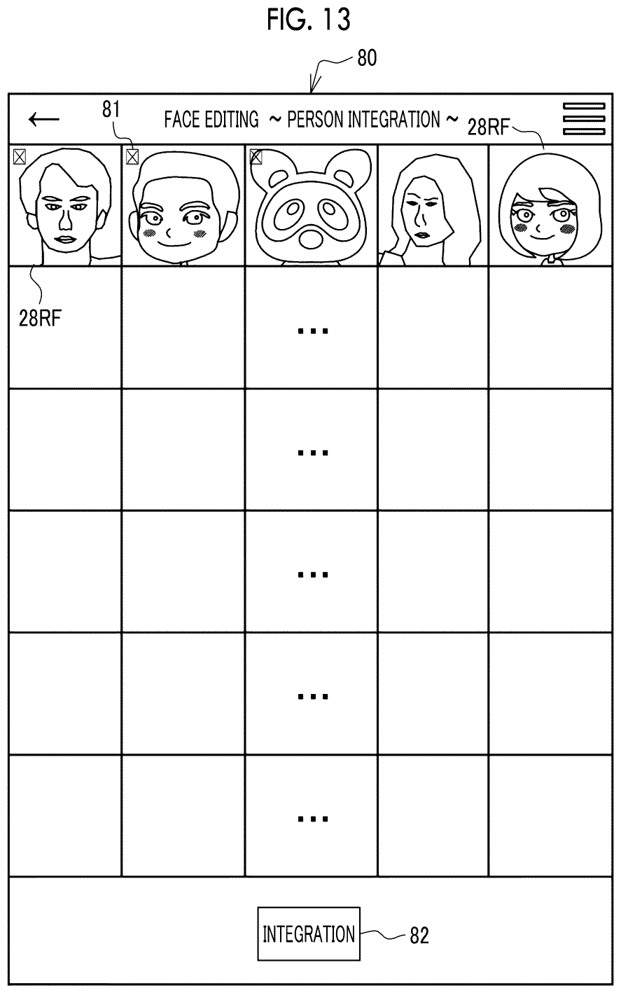

The integrated face ID is an ID for treating a plurality of faces FC, which are faces FC corresponding to the same user U but have different appearances because the faces FC are in a plurality of different spaces, as faces corresponding to the same user U. FIG. 8 shows an example in which FCP0001 is registered as the integrated face ID for the face FC having the face IDs of FC0001, FC0002, and FC0003. Further, FIG. 8 shows an example in which FCP0002 is registered as the integrated face ID for the faces FC having the face IDs of FC0004 and FC0005. The integrated face ID is also registered manually by the user U (see FIGS. 13 to 15).

As described above, since the name, the relationship, and the integrated face ID are registered manually by the user U, there is a face FC for which the name, the relationship, and the integrated face ID are not registered in the face list 53. For example, the integrated face ID is not registered for the face FC having the face ID of FC0035. In addition, for example, the name, the relationship, and the integrated face ID are not registered for the face FC having the face ID of FC0099. The reason why the integrated face ID is not registered is, for example, the user U who does not act in the virtual space VS. The reason why the name, the relationship, and the integrated face ID are not registered is that the person is not the acquaintance of the user U, but is a person who is accidentally shown in the image 28.

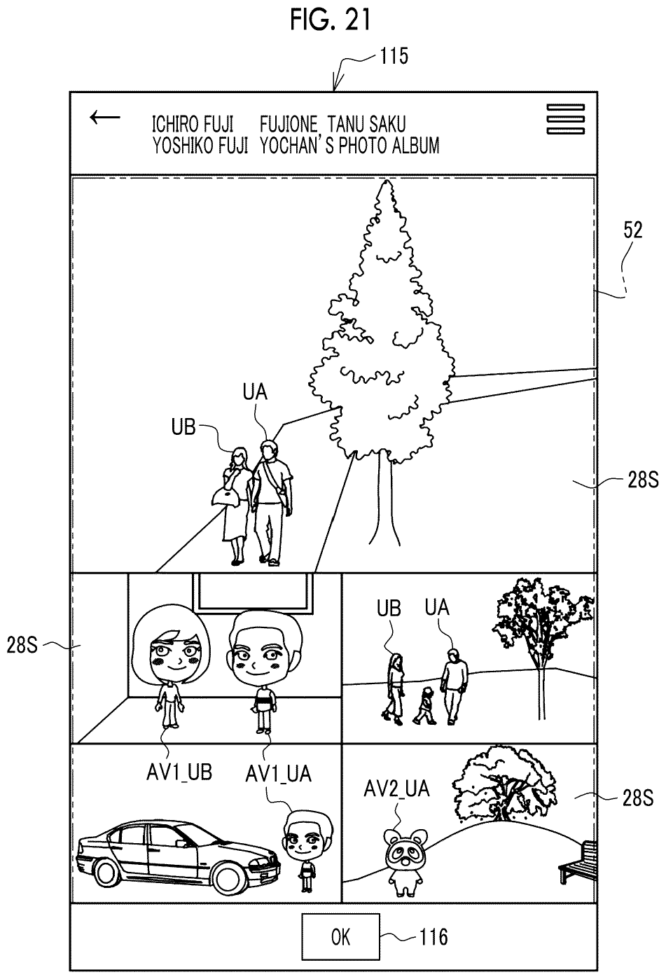

In the following description, the user U of the name “Yoshiko Fuji” having the face ID of FC0004 may be referred to as the user UB. In addition, the first avatar AV1in the first virtual space VS1 having the name “YOCHAN” having the face ID of FC0005 may be referred to as a first avatar AV1_UB (see FIG. 21).

As shown in FIG. 10 as an example, the editing unit 46 has various image quality adjustment units such as a brightness adjustment unit 60 that adjusts the brightness of the image 28, and various display change units such as an effect unit 61 that performs various types of effect processing such as dynamic, sepia, and monochrome on the image 28. Further, the editing unit 46 includes a face ID recognition unit 62 and an association unit 63. The editing unit 46 further includes an album creation unit 64 that creates the photo album 52. Hereinafter, processing of the editing unit 46 in a case in which various requests are received by the request reception unit 45 will be described in sequence.

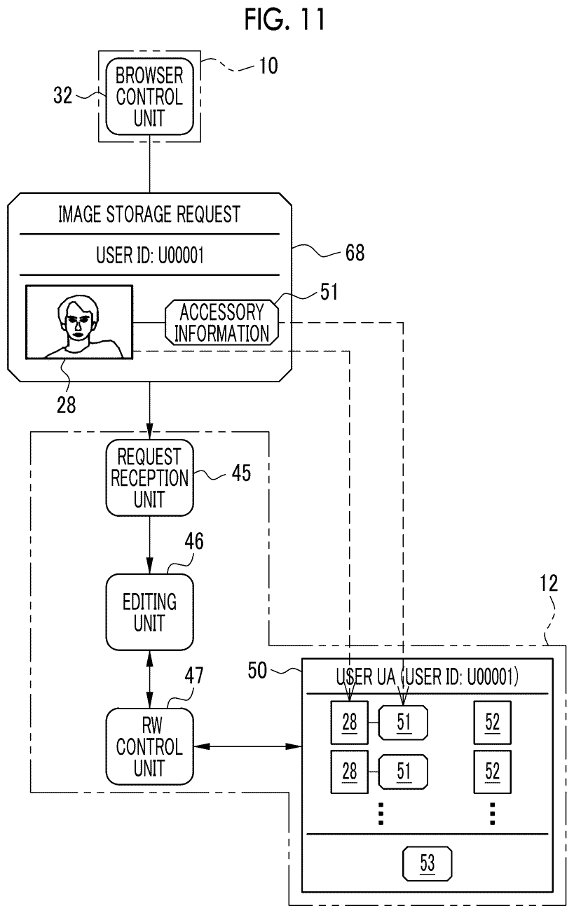

As shown in FIG. 11 as an example, the browser control unit 32 transmits a image storage request 68 of a newly obtained image 28 to the image management server 12 at an appropriate timing such as when the image AP 30 is activated. The image storage request 68 includes the user ID, the image 28, and the accessory information 51. The request reception unit 45 receives the image storage request 68 to output the image storage request 68 to the editing unit 46. The editing unit 46 performs processing in response to the image storage request 68, and outputs the image 28 and the accessory information 51 to the RW control unit 47. The RW control unit 47 stores the image 28 and the accessory information 51 in the storage area 50 of the image DB 36 corresponding to the user ID.

As shown in FIG. 12 as an example, at a point in time when the image storage request 68 is received by the request reception unit 45, it is unclear what kind of subject is shown in the image 28 of the image storage request 68, and what kind of face FC is shown. Therefore, the item of the face ID of the accessory information 51 of the image storage request 68 is blank as shown by an ellipse of a two-dot chain line. Therefore, the face ID recognition unit 62 performs processing of recognizing what kind of face FC is shown in the image 28 of the image storage request 68.

The face ID recognition unit 62 includes a face extraction unit 70, a face feature value derivation unit 71, a collation unit 72, and a face ID write unit 73. The image 28 of the image storage request 68 is input to the face extraction unit 70. The face extraction unit 70 extracts the face FC from the image 28 using a well-known face extraction technique, and generates the face image 28F by trimming a portion of the face FC from the image 28. The face extraction unit 70 outputs the face image 28F to the face feature value derivation unit 71. The face FC extracted by the face extraction unit 70 is an example of a “face of which face identification information is unknown” according to the technology of the present disclosure.

The face feature value derivation unit 71 derives the face feature value ZF from the face image 28F. For example, the face feature value derivation unit 71 extracts various feature points of the face FC, such as the inner canthus, the outer canthus, the medial eyebrow, the lateral eyebrow, the pupil, the nostril, and the mouth corner, from the face image 28F, and derives a feature value representing a distance between the various feature points and a shape of a polygonal region formed by connecting three or more feature points, as the face feature value ZF. Instead of or in addition to this, the face feature value derivation unit 71 may input the face image 28F to a machine learning model to derive the feature value output from the machine learning model as the face feature value ZF. The face feature value derivation unit 71 outputs the face feature value ZF to the collation unit 72. The face feature value ZF derived by the face feature value derivation unit 71 is an example of a “feature value of a face of which face identification information is unknown” and “derived feature value” according to the technology of the present disclosure.

The collation unit 72 collates the face feature value ZF from the face feature value derivation unit 71 with the representative face feature value ZRF in the face list 53. Here, a distance between the two face feature values ZF of the two faces FC in the feature value space 55 can be used as an indicator indicating the similarity between the two faces FC. That is, it can be said that the closer the distance between the two face feature values ZF in the feature value space 55 is, the higher the similarity between the two faces FC is. On the contrary, it can be said that the farther the distance between the two face feature values ZF in the feature value space 55 is, the lower the similarity between the two faces FC is. Therefore, the collation unit 72 exhaustively calculates the distance in the feature value space 55 between the face feature value ZF from the face feature value derivation unit 71 and the representative face feature value ZRF of each face FC in the face list 53. Then, the collation unit 72 recognizes the face ID of the face FC, which is registered in the face list 53 and in which the distance between the face feature value ZF from the face feature value derivation unit 71 and the representative face feature value ZRF is the shortest (the distance is the minimum value), and the distance is less than a threshold value set in advance, as the face ID of the face FC shown in the image 28 of the image storage request 68. The collation unit 72 outputs a collation result 74 including the recognized face ID to the face ID write unit 73. FIG. 12 shows an example in which the face FC having the face ID of FC0001 in the face list 53 is recognized as the face FC shown in the image 28 of the image storage request 68.

The face ID write unit 73 writes the face ID of the collation result 74 from the collation unit 72 in the item of the face ID of the accessory information 51 of the image storage request 68. In this way, the face ID recognition unit 62 recognizes which face ID of the face list 53 corresponds to the face FC shown in the image 28 of the image storage request 68.

In a case in which the plurality of faces FC are extracted from the image 28 of the image storage request 68 in the face extraction unit 70, the derivation of the face feature value ZF by the face feature value derivation unit 71, the collation by the collation unit 72, and the writing of the face ID by the face ID write unit 73 are performed for each of the plurality of faces FC. Therefore, in such a case, a plurality of face IDs are registered in the item of the face ID of the accessory information 51.

In the face extraction unit 70, in a case in which the face FC is not extracted from the image 28 of the image storage request 68, the derivation of the face feature value ZF by the face feature value derivation unit 71, the collation by the collation unit 72, and the writing of the face ID by the face ID write unit 73 are not performed. In such a case, the image 28 and the accessory information 51 of the image storage request 68 are output from the editing unit 46 to the RW control unit 47 as they are.

In a case in which the minimum value of the distance between the face feature value ZF from the face feature value derivation unit 71 and the representative face feature value ZRF is equal to or greater than the threshold value, the processing is performed as follows. That is, the collation unit 72 newly provides a field in the face list 53. Then, the collation unit 72 registers a new face ID in the newly provided field, registers the face image 28F from the face extraction unit 70 as the representative face image 28RF, and registers the face feature value ZF from the face feature value derivation unit 71 as the representative face feature value ZRF. In addition, the face ID write unit 73 writes the newly registered face ID in the item of the face ID of the accessory information 51 of the image storage request 68.

The fact that the minimum value of the distance between the face feature value ZF from the face feature value derivation unit 71 and the representative face feature value ZRF is equal to or greater than the threshold value means that the face FC corresponding to the face FC shown in the image 28 of the image storage request 68 is not registered in the face list 53. Therefore, in a case in which the minimum value of the distance between the face feature value ZF from the face feature value derivation unit 71 and the representative face feature value ZRF is equal to or greater than the threshold value, a field is newly provided in the face list 53 as described above, and the face ID and the like are newly registered.

As shown in FIG. 13 as an example, the browser control unit 32 displays a face editing screen 80 on the display 24A in response to the instruction from the user U. The representative face image 28RF, the name, and the relationship can be registered on the face editing screen 80. As will be described below, the registration of the integrated face ID in the face FC corresponding to the same user U can also be performed.

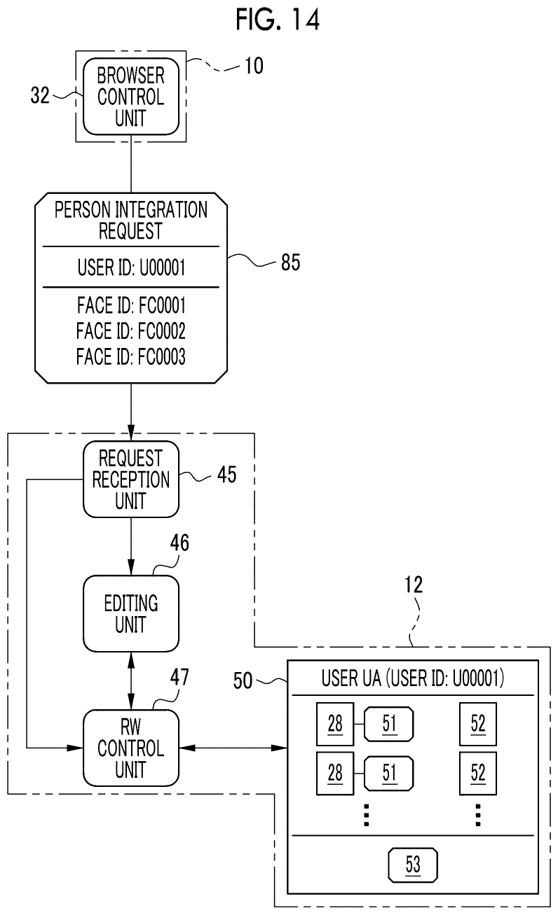

The face editing screen 80 shown in FIG. 13 is a screen for registering the integrated face ID. The representative face image 28RF of the face FC of which the face ID is registered in the face list 53 is displayed in a list on the face editing screen 80. The user U can select the representative face image 28RF for which the integrated face ID is desired to be registered, from among the representative face images 28RF displayed in a list. A check mark 81 is displayed on the representative face image 28RF selected by the user U. The user U selects a desired representative face image 28RF and then presses an integration button 82. FIG. 13 shows a case in which the faces FC having the face IDs of FC0001, FC0002, and FC0003 are selected as the faces FC for which the integrated face ID is registered (see also FIG. 14).

In a case in which the integration button 82 is pressed on the face editing screen 80, as shown in FIG. 14 as an example, the browser control unit 32 transmits a person integration request 85 to the image management server 12. The person integration request 85 includes the user ID and the face ID of the face FC shown in the representative face image 28RF selected on the face editing screen 80. The request reception unit 45 receives the person integration request 85 to output the person integration request 85 to the editing unit 46 and the RW control unit 47.

The RW control unit 47 reads out the face list 53 stored in the storage area 50 corresponding to the user ID of the person integration request 85 and outputs the read-out face list 53 to the editing unit 46. The editing unit 46 performs processing on the face list 53 in response to the person integration request 85 and outputs the processed face list 53 to the RW control unit 47. The RW control unit 47 stores the processed face list 53 from the editing unit 46 in the original storage arca 50.

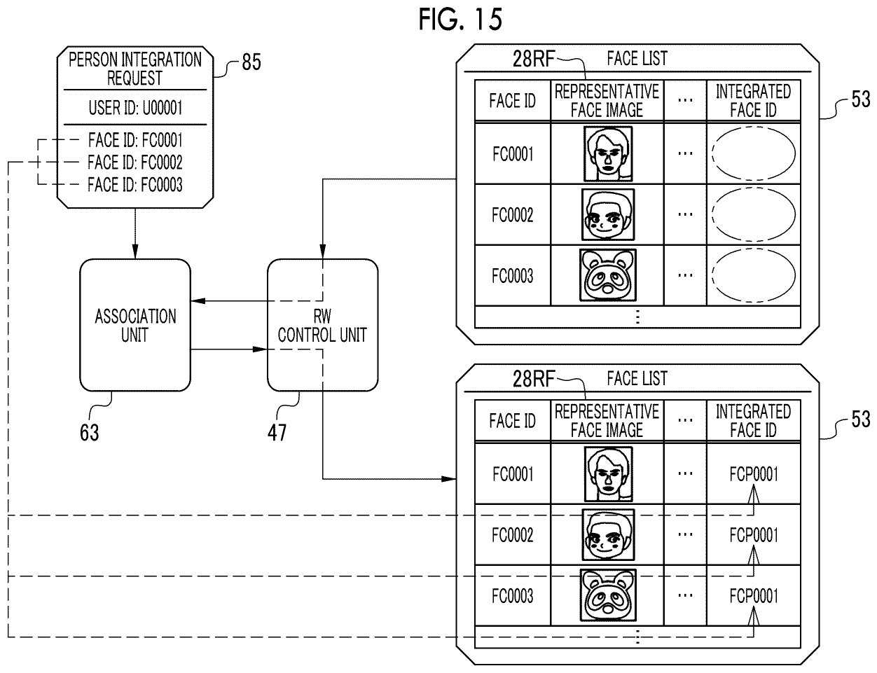

As shown in FIG. 15 as an example, the association unit 63 registers a new integrated face ID in the item of the integrated face ID of the face ID of the person integration request 85 in the face list 53 from the RW control unit 47. The association unit 63 registers the integrated face ID in the face list 53 in this way and edits the face list 53 to associate the plurality of faces FC that correspond to the same user U and that have different appearances in the plurality of spaces.

Instead of registering the integrated face ID, the association between the plurality of faces FC that correspond to the same user U and that have different appearances in the plurality of spaces may be performed by integrating the face IDs into one. In the example of FIG. 15, FC0001 of the face ID is unchanged, and FC0002 and FC0003 are rewritten to FC0001.

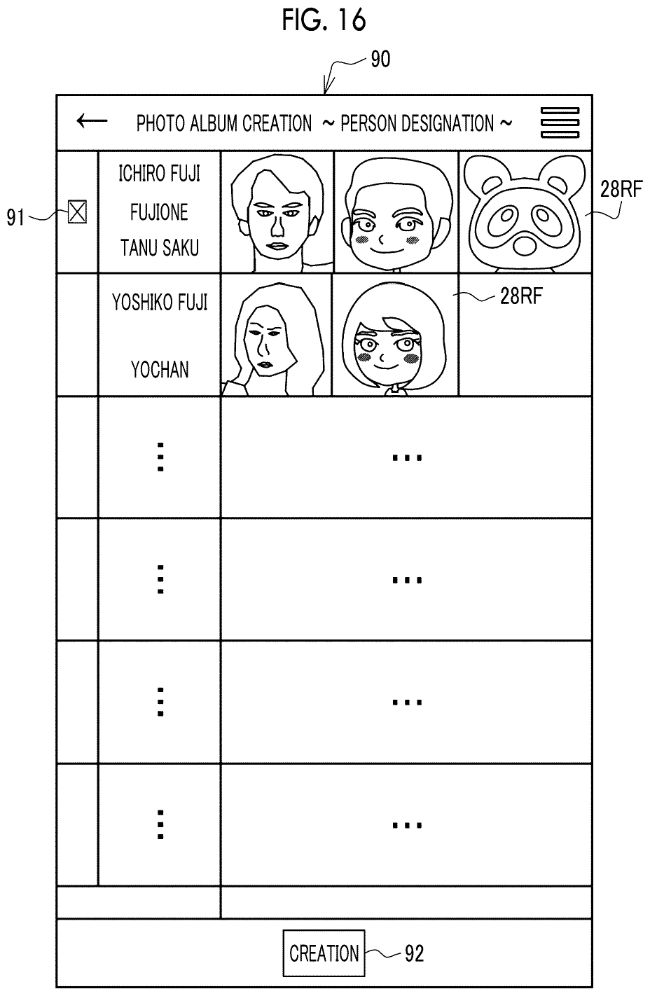

As shown in FIG. 16 as an example, the browser control unit 32 displays an album creation screen 90 on the display 24A in response to the instruction from the user U. The album creation screen 90 shown in FIG. 16 is a screen for creating the photo album 52 related to the designated user U. The representative face image 28RF of the face FC of which the face ID is registered in the face list 53 is displayed in a list together with the name on the album creation screen 90. For the plurality of faces FC of the same user U that are in different spaces and for which the integrated face ID is registered, the representative face images 28RF are collectively displayed in a row. In addition, the representative face image 28RF of the real space RS may be displayed relatively larger than the representative face image 28RF of the virtual space VS.

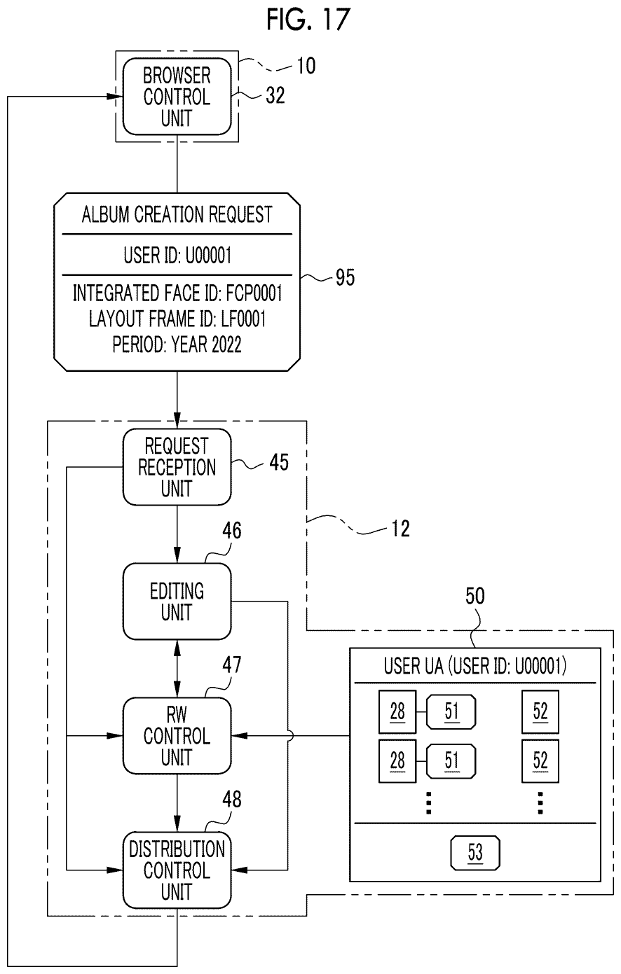

The user U can select the user U who wants to create the photo album 52 (hereinafter, referred to as a target user U_T) from among the plurality of users U (including the user U himself/herself) for which the names and the representative face images 28RF are displayed in a list. A check mark 91 is displayed for the target user U_T selected by the user U. The user U selects a desired target user U_T and then presses a creation button 92. FIG. 16 shows a case in which the user UA of the face FC having the integrated face ID of FCP0001 is selected as the target user U_T (see also FIG. 17). Although not shown, on the album creation screen 90, it is possible to select the layout frame of the photo album 52 or to designate a period of the imaging date and time of the image 28 used in the photo album 52. All the images 28 stored in the storage area 50 may be used as the targets of the photo album 52 without particularly designating the period of the imaging date and time of the image 28 used in the photo album 52.

In a case in which the creation button 92 is pressed on the album creation screen 90, as shown in FIG. 17 as an example, the browser control unit 32 transmits an album creation request 95 to the image management server 12. The album creation request 95 includes the user ID and the face ID or the integrated face ID of the target user U_T selected on the album creation screen 90. In a case in which the user U of the face FC for which the integrated face ID is not registered is selected as the target user U_T, the browser control unit 32 registers the face ID in the album creation request 95. On the other hand, in a case in which the user U of the face FC for which the integrated face ID is registered is selected as the target user U_T as in the present example, the browser control unit 32 registers the integrated face ID in the album creation request 95 as shown. The album creation request 95 also includes a layout frame ID of the layout frame selected on the album creation screen 90 and the period of the imaging date and time of the image 28 designated on the album creation screen 90.

The request reception unit 45 receives the album creation request 95 to output the album creation request 95 to the editing unit 46, the RW control unit 47, and the distribution control unit 48. The RW control unit 47 reads out the image 28 captured in the period of the designated imaging date and time and the accessory information 51 from the storage area 50 corresponding to the user ID of the album creation request 95, and outputs the read-out image 28 and accessory information 51 to the editing unit 46.

The editing unit 46 performs processing in response to the album creation request 95, and creates the photo album 52 based on the image 28 from the RW control unit 47. The editing unit 46 outputs the created photo album 52 to the distribution control unit 48. The distribution control unit 48 distributes the photo album 52 to the user terminal 10, which is a request source of the album creation request 95. In this case, the distribution control unit 48 specifies the user terminal 10, which is the request source of the album creation request 95, based on the user ID of the album creation request 95.

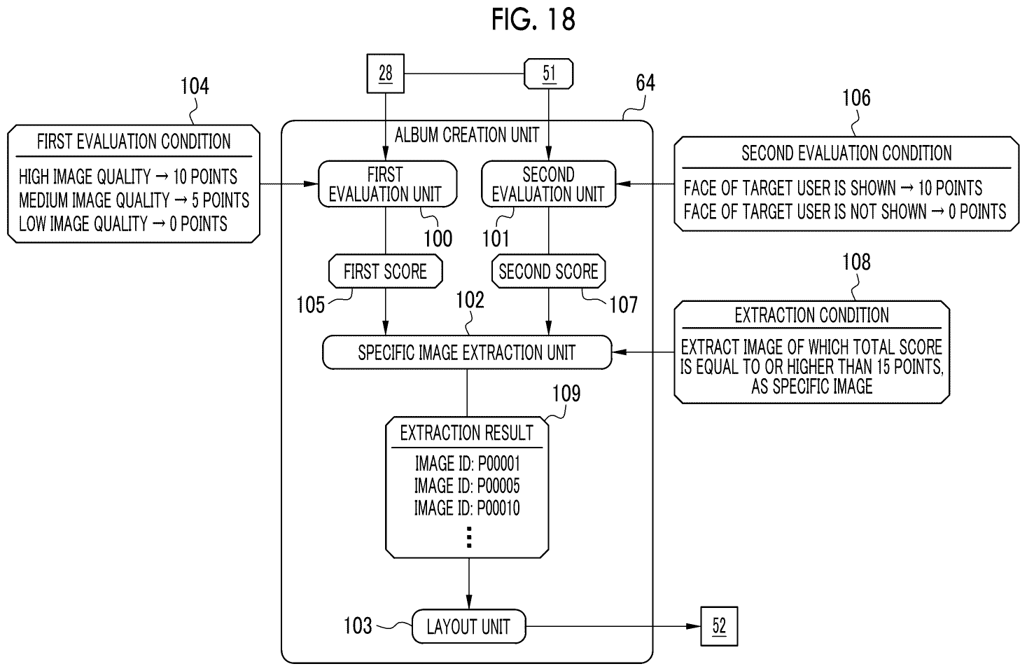

As shown in FIG. 18 as an example, the album creation unit 64 includes a first evaluation unit 100, a second evaluation unit 101, a specific image extraction unit 102, and a layout unit 103. The image 28 is input to the first evaluation unit 100. The first evaluation unit 100 analyzes the image 28 and derives an image quality evaluation value of the image 28. The image quality evaluation value is a summary of results of evaluation for a plurality of evaluation items such as whether or not each of an exposure value, a shutter speed, and an F number of the image 28 is appropriate, whether or not blurring and out-of-focus occur, whether or not sharpness is high, whether or not a composition is likely to be selected for the photo album 52, whether or not the face FC is shown, and whether or not the face FC is shown, in a case in which the face FC is shown, whether it is smiling or not. Alternatively, the image quality evaluation value may be derived using a machine learning model that outputs the image quality evaluation value in response to the input of the image 28.

The first evaluation unit 100 assigns a first score 105 to the image 28 based on a first evaluation condition 104. The first evaluation condition 104 has contents in which the first score 105 is set to 10 points in a case in which the image quality evaluation value is equal to or greater than a first threshold value (high image quality), the first score 105 is set to 5 points in a case in which the image quality evaluation value is equal to or greater than a second threshold value and less than the first threshold value (medium image quality), and the first score 105 is set to 0 points in a case in which the image quality evaluation value is less than the second threshold value (low image quality). The first evaluation unit 100 assigns the first score 105 to each of all the images 28 read out by the RW control unit 47. The first evaluation unit 100 outputs the first score 105 to the specific image extraction unit 102.

The accessory information 51 is input to the second evaluation unit 101. The second evaluation unit 101 assigns a second score 107 to the image 28 based on a second evaluation condition 106. The second evaluation condition 106 has contents in which, in a case in which the face ID of the face FC of the target user U_T is registered in the item of the face ID of the accessory information 51, that is, in a case in which the face FC of the target user U_T is shown in the image 28, the second score 107 is set to 10 points, and in a case in which the face ID of the face FC of the target user U_T is not registered in the item of the face ID of the accessory information 51, that is, in a case in which the face FC of the target user U_T is not shown in the image 28, the second score 107 is set to 0 points. As described above, the second evaluation unit 101 assigns a higher second score 107 to the image 28 showing the face FC of the target user U_T than the image 28 not showing the face FC of the target user U_T. The second evaluation unit 101 assigns the second score 107 to each of all the images 28 read out by the RW control unit 47. The second evaluation unit 101 outputs the second score 107 to the specific image extraction unit 102.

The specific image extraction unit 102 calculates a total score by adding up the first score 105 and the second score 107. The total score is 20 points as the highest point and 0 points as the lowest point. The total score is 20 points in a case in which the image quality evaluation value of the image 28 is equal to or greater than the first threshold value (high image quality) and the face FC of the target user U_T is shown in the image 28. The case in which the total score is 0 points is a case in which the image quality evaluation value of the image 28 is less than the second threshold value (low image quality) and the face FC of the target user U_T is not shown in the image 28.

The specific image extraction unit 102 extracts a specific image 28S, which is the image 28 to be used for the photo album 52, from among the images 28 read out by the RW control unit 47 based on an extraction condition 108. The extraction condition 108 has contents in which the image 28 of which the total score is equal to or higher than 15 points is extracted as the specific image 28S. The total score is equal to or higher than 15 points in a case in which the image quality evaluation value of the image 28 is equal to or greater than the first threshold value (high image quality) or is equal to or greater than the second threshold value and less than the first threshold value (medium image quality), and the face FC of the target user U_T is shown in the image 28. Therefore, the specific image 28S always includes the image 28 showing the face FC of the target user U_T.

The specific image extraction unit 102 outputs an extraction result 109 of the specific image 28S to the layout unit 103. The image ID of the specific image 28S is included in the extraction result 109. The layout unit 103 creates the photo album 52 by laying out the specific image 28S in the layout frame of the layout frame ID of the album creation request 95 as appropriate.

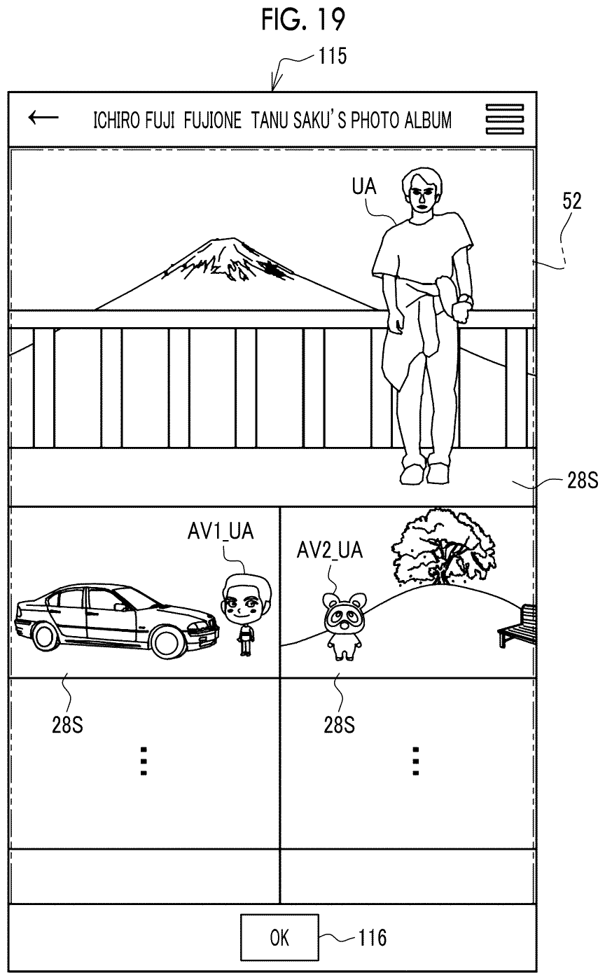

As shown in FIG. 19 as an example, the browser control unit 32 receives the distribution of the photo album 52 from the image management server 12, and displays an album display screen 115 including the distributed photo album 52 on the display 24A. FIG. 19 shows a case in which the user UA is designated as the target user U_T. In this case, the image 28 showing the real face FC of the user UA in the real space RS, the image 28 showing the face FC of the first avatar AV1_UA of the user UA in the first virtual space VS1, and the image 28 showing the face FC of the second avatar AV2_UA of the user UA in the second virtual space VS2 are extracted as the specific images 28S and used in the photo album 52.

In a case in which the user U likes the photo album 52 displayed on the album display screen 115, the user U presses an OK button 116. In a case in which the OK button 116 is pressed, the browser control unit 32 transmits an album storage request to the image management server 12. Although not shown, the album storage request includes the user ID and the photo album 52 displayed on the album display screen 115. The request reception unit 45 receives the album storage request to output the album storage request to the RW control unit 47. The RW control unit 47 stores the photo album 52 of the album storage request, in the storage area 50 corresponding to the user ID of the album storage request. The photo album 52 can be viewed on the album display screen 115 or stored in the storage 20B of the image management server 12, and can also be printed by ordering a printing company to enjoy the photo album as a real photo book.

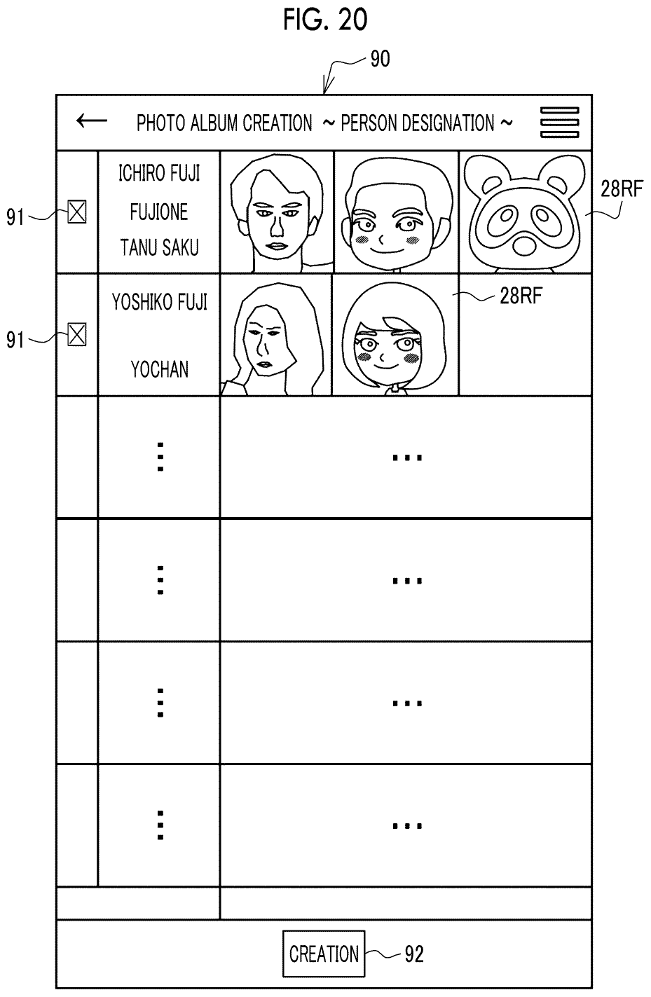

FIG. 16 shows a case in which only one target user U_T is designated, but the technology of the present disclosure is not limited to this. As shown in FIG. 20 as an example, a plurality of target users U_T may be designated. FIG. 20 shows a case in which the user UA of the face FC having the integrated face ID of FCP0001 and the user UB of the face FC having the integrated face ID of FCP0002 are selected as the target users U_T.

In this case, the second score 107 of the image 28 showing the real face FC of the user UA in the real space RS and the real face FC of the user UB in the real space RS together has 10+10=20 points. The second score 107 of the image 28 showing the face FC of the first avatar AV1_UA of the user UA in the first virtual space VS1 and the face FC of the first avatar AV1_UB of the user UB in the first virtual space VS1 together has also 20 points. Therefore, the specific image 28S used in the photo album 52 is, as an example, the photo album 52 displayed on the album display screen 115 shown in FIG. 21. That is, the image 28 showing the real face FC of the user UA in the real space RS and the real face FC of the user UB in the real space RS together, the image 28 showing the face FC of the first avatar AV1_UA of the user UA in the first virtual space VS1 and the face FC of the first avatar AV1_UB of the user UB in the first virtual space VS1 together, and the like are extracted as the specific images 28S and used in the photo album 52.

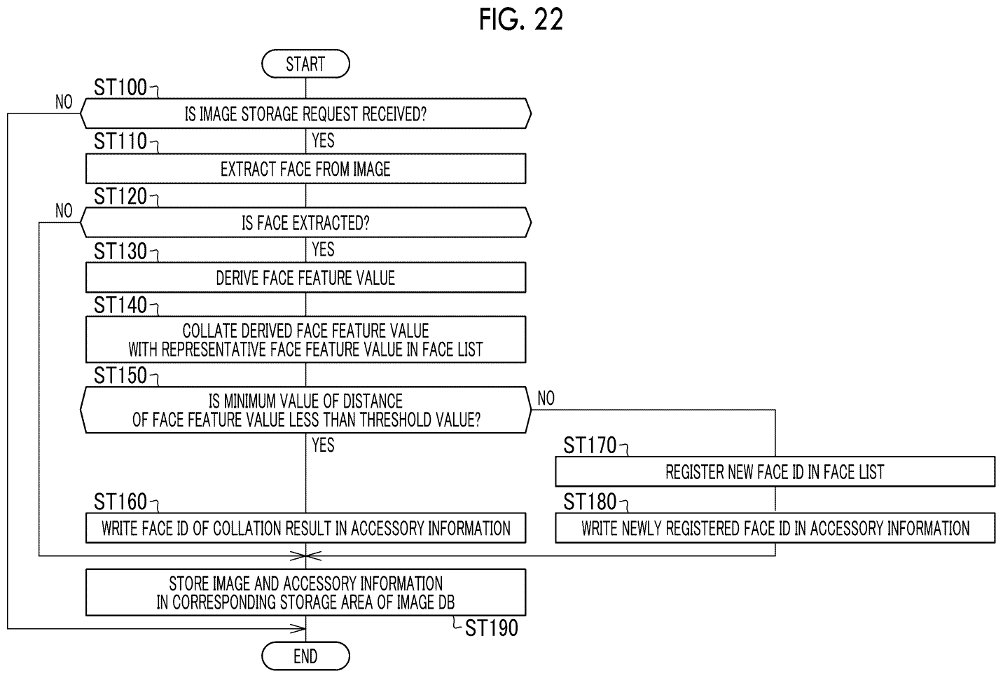

Next, an operation of the configuration described above will be described with reference to the flowchart shown in FIGS. 22 to 24 as an example. As shown in FIG. 4, the CPU 22A of the user terminal 10 functions as the browser control unit 32 by activation of the image AP 30. In addition, as shown in FIG. 5, the CPU 22B of the image management server 12 functions as the request reception unit 45, the editing unit 46, the RW control unit 47, and the distribution control unit 48 by activation of the operation program 35.

The user UA captures the image 28 with the camera function and the screen capture function of the user terminal 10. As shown in FIG. 11, under the control of the browser control unit 32, the image storage request 68 including the image 28 and the accessory information 51 is transmitted to the image management server 12.

In the image management server 12, the request reception unit 45 receives the image storage request 68 (YES in step ST100 of FIG. 22). The image storage request 68 is output from the request reception unit 45 to the editing unit 46.

As shown in FIG. 12, in the face ID recognition unit 62 of the editing unit 46, the face FC is extracted from the image 28 of the image storage request 68 by the face extraction unit 70 (step ST110). In a case in which the face FC is extracted from the image 28 (YES in step ST120), the processing proceeds to step ST130. On the other hand, in a case in which the face FC is not extracted from the image 28 (NO in step ST120), the processing proceeds to step ST190, the image 28 and the accessory information 51 of the image storage request 68 are stored in the corresponding storage area 50 of the image DB 36 under the control of the RW control unit 47, and the processing ends.

In a case in which the face FC is extracted from the image 28 (YES in step ST120), the face image 28F is generated by trimming the portion of the face FC from the image 28 in the face extraction unit 70. The face image 28F is output from the face extraction unit 70 to the face feature value derivation unit 71.

The face feature value ZF is derived from the face image 28F by the face feature value derivation unit 71 (step ST130). The face feature value ZF is output from the face feature value derivation unit 71 to the collation unit 72.

The collation unit 72 collates the face feature value ZF from the face feature value derivation unit 71 with the representative face feature value ZRF of the face list 53 (step ST140). Specifically, the distance in the feature value space 55 between the face feature value ZF from the face feature value derivation unit 71 and the representative face feature value ZRF of each face FC of the face list 53 is calculated. Then, the calculated minimum value of the distance is compared with the threshold value. In a case in which the minimum value of the distance is less than the threshold value (YES in step ST150), the collation unit 72 recognizes the face ID of the face FC of which the distance is the minimum value, as the face ID of the face FC shown in the image 28 of the image storage request 68. The collation unit 72 generates the collation result 74 including the recognized face ID. The collation result 74 is output from the collation unit 72 to the face ID write unit 73. Then, the face ID of the collation result 74 from the collation unit 72 is written in the item of the face ID of the accessory information 51 of the image storage request 68 by the face ID write unit 73 (step ST160). Thereafter, the image 28 and the accessory information 51 are stored in the corresponding storage area 50 of the image DB 36 under the control of the RW control unit 47, and the processing ends (step ST190).

On the other hand, in a case in which the minimum value of the distance is equal to or greater than the threshold value (NO in step ST150), a new field is provided in the face list 53 by the collation unit 72, and a new face ID is registered in the newly provided field (step ST170). In addition, the collation unit 72 registers the face image 28F from the face extraction unit 70 as the representative face image 28RF, and registers the face feature value ZF from the face feature value derivation unit 71 as the representative face feature value ZRF. Then, the face ID write unit 73 writes the newly registered face ID in the item of the face ID of the accessory information 51 of the image storage request 68 (step ST180). Thereafter, the image 28 and the accessory information 51 are stored in the corresponding storage area 50 of the image DB 36 under the control of the RW control unit 47, and the processing ends (step ST190). As described above, the face ID recognition unit 62 recognizes which face ID of the face list 53 corresponds to the face FC shown in the image 28 of the image storage request 68.

Next, in a case in which the representative face image 28RF for which the user U wants to register the integrated face ID is selected and the integration button 82 is pressed in the face editing screen 80 shown in FIG. 13, as shown in FIG. 14, under the control of the browser control unit 32, the person integration request 85 including the face ID of the face FC shown in the selected representative face image 28RF is transmitted to the image management server 12.

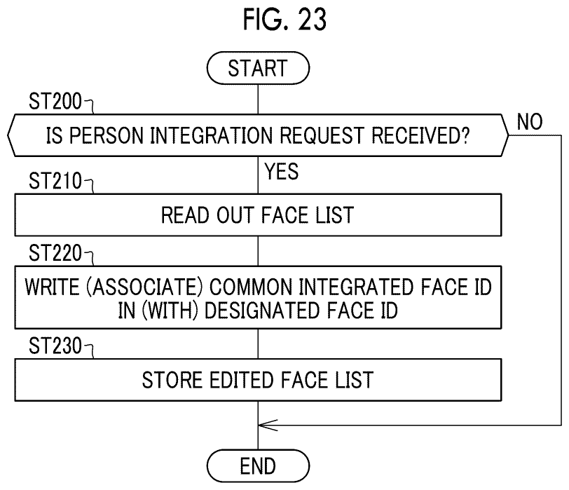

In the image management server 12, the request reception unit 45 receives the person integration request 85 (YES in step ST200 of FIG. 23). The person integration request 85 is output from the request reception unit 45 to the editing unit 46 and the RW control unit 47.

The RW control unit 47 reads out the face list 53 stored in the storage area 50 corresponding to the user ID of the person integration request 85 and outputs the read-out face list 53 to the editing unit 46 (step ST210). As shown in FIG. 15, the association unit 63 of the editing unit 46 registers the new integrated face ID in the item of the integrated face ID of the face ID of the person integration request 85 in the face list 53 from the RW control unit 47. In this way, the face list 53 is edited by the association unit 63, and the association of the plurality of faces FC that correspond to the same user U and that have different appearances in the plurality of spaces is performed (step ST220).

The edited face list 53 is output from the association unit 63 to the RW control unit 47. Then, the edited face list 53 is stored in the original storage area 50 under the control of the RW control unit 47 (step ST230).

Next, in a case in which the target user U_T for which the user U wants to create the photo album 52 is selected and the creation button 92 is pressed in the album creation screen 90 shown in FIG. 16, as shown in FIG. 17, the album creation request 95 including the face ID or the integrated face ID of the face FC of the target user U_T is transmitted to the image management server 12 under the control of the browser control unit 32.

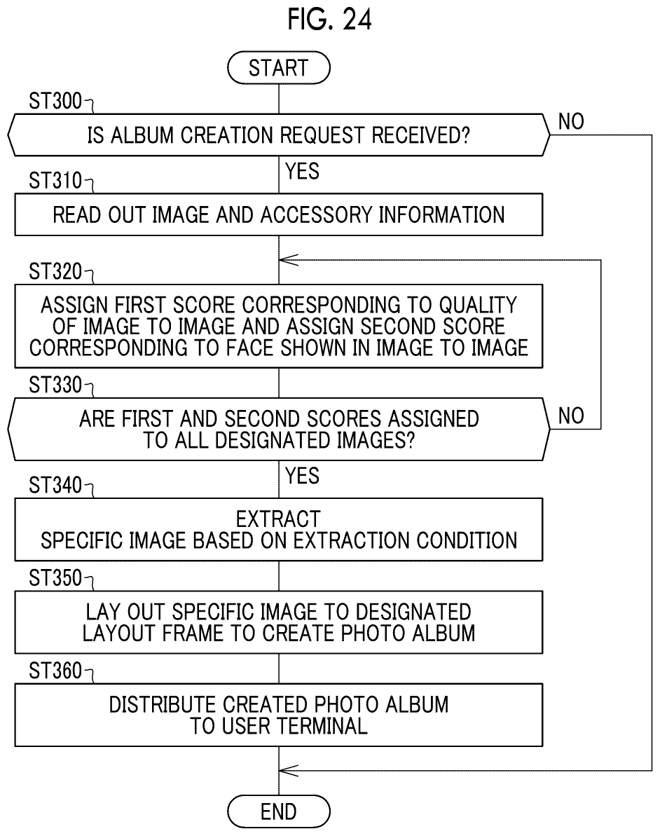

In the image management server 12, the request reception unit 45 receives the album creation request 95 (YES in step ST300 of FIG. 24). The album creation request 95 is output from the request reception unit 45 to the editing unit 46, the RW control unit 47, and the distribution control unit 48.

The RW control unit 47 reads out the image 28 captured in the period of the designated imaging date and time and the accessory information 51 from the storage area 50 corresponding to the user ID of the album creation request 95, and outputs the read-out image 28 and accessory information 51 to the editing unit 46 (step ST310). As shown in FIG. 18, in the album creation unit 64 of the editing unit 46, the first evaluation unit 100 assigns the first score 105 corresponding to the image quality of the image 28 to the image 28 based on the first evaluation condition 104 (step ST320). In addition, the second evaluation unit 101 assigns the second score 107 corresponding to the face FC shown in the image 28 to the image 28 based on the second evaluation condition 106 (step ST320). The first score 105 is output from the first evaluation unit 100 to the specific image extraction unit 102. Further, the second score 107 is output from the second evaluation unit 101 to the specific image extraction unit 102. The processing of step ST320 is continued during a period in which the first score 105 and the second score 107 are not added to all the images 28 read out by the RW control unit 47 (NO in step ST330).

The total score by adding up the first score 105 and the second score 107 is calculated by the specific image extraction unit 102. Next, the specific image 28S that is the image 28 to be used in the photo album 52 is extracted from the images 28 read out by the RW control unit 47 based on the extraction condition 108 (step ST340). The extraction result 109 including the image ID of the specific image 28S is generated by the specific image extraction unit 102. The extraction result 109 is output from the specific image extraction unit 102 to the layout unit 103.

The layout unit 103 lays out the specific image 28S in the designated layout frame as appropriate, to create the photo album 52 (step ST350). The photo album 52 is output from the layout unit 103 to the distribution control unit 48 and is distributed to the user terminal 10 that is the request source of the album creation request 95 under the control of the distribution control unit 48 (step ST360).

As described above, the RW control unit 47 of the CPU 22B of the image management server 12 acquires the plurality of images 28 showing the plurality of different spaces including at least one virtual space VS in which the avatar AV of the user U acts. The association unit 63 of the editing unit 46 associates the plurality of faces FC that are shown in the image 28, that correspond to the same user U, and that have different appearances in the plurality of spaces. Therefore, the plurality of faces FC that are the same face FC corresponding to the same user U but have different appearances due to being in the plurality of different spaces can be treated as the faces FC corresponding to the same user U. The images 28 showing the plurality of faces FC corresponding to the same user U and having different appearances in the plurality of spaces can be efficiently organized as the images 28 belonging to the same user U.

As shown in FIG. 3, the plurality of spaces include a plurality of virtual spaces VS. The plurality of faces FC having different appearances include the faces FC of the avatars AV in the plurality of virtual spaces VS. Therefore, for example, it is possible to treat the face FC of the first avatar AV1_UA of the user UA in the first virtual space VS1 and the face FC of the second avatar AV2_UA of the user UA in the second virtual space VS2 as the faces FC corresponding to the same user UA. Then, for example, as shown in FIG. 19, it is possible to easily create the photo album 52 in which the image 28 showing the face FC of the first avatar AV1_UA of the user UA in the first virtual space VS1 and the image 28 showing the face FC of the second avatar AV2_UA of the user UA in the second virtual space VS2 are mixed without bothering the user U.

In addition, as shown in FIG. 3, the plurality of spaces include the virtual space VS and the real space RS. Further, the plurality of faces FC having different appearances include the face FC of the avatar AV in the virtual space VS and the real face FC of the user U in the real space RS. Therefore, for example, it is possible to treat the real face FC of the user UA in the real space RS, the face FC of the first avatar AV1_UA of the user UA in the first virtual space VS1 and the face FC of the second avatar AV2_UA of the user UA in the second virtual space VS2 as the faces FC corresponding to the same user UA. Then, for example, as shown in FIG. 19, it is possible to easily create, without bothering the user U, the photo album 52 in which the image 28 showing the real face FC of the user UA in the real space RS, the image 28 showing the face FC of the first avatar AV1_UA of the user UA in the first virtual space VS1 and the image 28 showing the face FC of the second avatar AV2_UA of the user UA in the second virtual space VS2 are mixed.

As shown in FIGS. 14 and 15, the RW control unit 47 acquires the face list 53 which is a list of face IDs of which a correspondence relationship with the representative face feature value ZRF is known. The association unit 63 performs the association by editing the face list 53. Therefore, it is possible to easily perform the association.

As shown in FIGS. 11 and 12, the RW control unit 47 acquires the face list 53 which is a list of face IDs of which a correspondence relationship with the representative face feature value ZRF is known. The face feature value derivation unit 71 derives the face feature value ZF of the face FC of which the face ID is unknown, from the image 28. The collation unit 72 recognizes which face ID of the face list 53 corresponds to the unknown face FC by collating the derived face feature value ZF with the representative face feature value ZRF in the face list 53. Therefore, it is possible to easily ascertain which face FC is shown in which image 28. The extraction of the specific image 28S used in the photo album 52 can be smoothly performed without delay.

As shown in FIG. 17, the request reception unit 45 receives the designation of the target user U_T by the album creation request 95. As shown in FIG. 18, the specific image extraction unit 102 extracts the specific image 28S including the image 28 showing the face FC of the target user U_T, from among the plurality of images 28, based on the result of the recognition of which face ID in the face list 53 corresponds to the unknown face FC. The layout unit 103 creates the photo album 52 based on the specific image 28S. Therefore, for example, as shown in FIG. 19, it is possible to easily create, without bothering the user U, the photo album 52 in which the image 28 showing the real face FC of the user UA in the real space RS, the image 28 showing the face FC of the first avatar AV1_UA of the user UA in the first virtual space VS1 and the image 28 showing the face FC of the second avatar AV2_UA of the user UA in the second virtual space VS2 are mixed.

As shown in FIGS. 20 and 21, there are the plurality of target users U_T. The specific image 28S includes the image 28 showing the faces FC of the plurality of target users U_T together. Therefore, as shown in FIG. 21 as an example, it is possible to easily create, without bothering the hand of the user U, the photo album 52 in which the image 28 showing the real face FC of the user UA in the real space RS and the real face FC of the user UB in the real space RS together, the image 28 showing the face FC of the first avatar AV1_UA of the user UA in the first virtual space VS1 and the face FC of the first avatar AV1_UB of the user UB in the first virtual space VS1 together, and the like are mixed.

It can be assumed that users U who are acquaintances in the real space RS often also engage in activities together in the virtual space VS. Therefore, not only in the real space RS but also in the virtual space VS, there is a high probability that the avatars AV of the users U who are acquaintances are shown in the same image 28. In such a case, it is assumed that there is an increasing demand for creating the photo album 52 not only including the image 28 showing the users U who are acquaintances in the real space RS but also including the image 28 showing the avatars AV of the users U who are acquaintances in the virtual space VS. According to the technology of the present disclosure, the plurality of faces FC that correspond to the same user U and that have different appearances in the plurality of spaces are treated as the faces FC that correspond to the same user U, so that it is possible to meet the above-described demand.

As shown in FIG. 18, the first evaluation unit 100 and the second evaluation unit 101 assign the first score 105 and the second score 107 to each of the plurality of images 28. The specific image extraction unit 102 extracts the specific image 28S based on the first score 105 and the second score 107. Therefore, the specific image 28S can be extracted in accordance with a clear standard such as the image quality of the image 28 and the face FC shown in the image 28.

As shown in FIG. 18, the second evaluation unit 101 assigns a higher second score 107 to the image 28 showing the face FC of the target user U_T than the image 28 not showing the face FC of the target user U_T. Therefore, the image 28 showing the face FC of the target user U_T is likely to be extracted as the specific image 28S.

### Second Embodiment

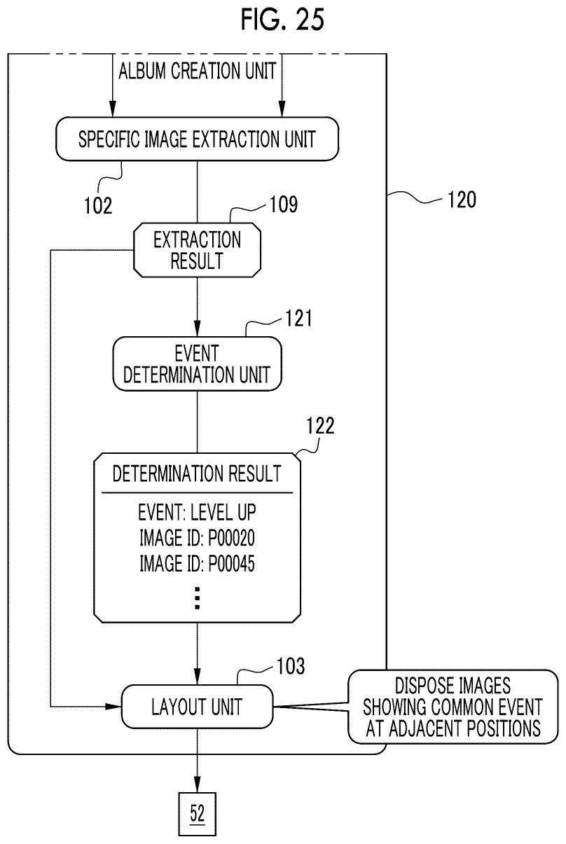

As shown in FIG. 25 as an example, an album creation unit 120 according to the second embodiment includes an event determination unit 121 in addition to the processing units 100 to 103 (the first evaluation unit 100 and the second evaluation unit 101 are not shown in FIG. 25) according to the first embodiment. The event determination unit 121 is provided between the specific image extraction unit 102 and the layout unit 103. The extraction result 109 is input from the specific image extraction unit 102 to the event determination unit 121.

The event determination unit 121 determines the specific image 28S showing a common event in different spaces among the specific images 28S of which the image ID is registered in the extraction result 109. Here, the event is a level up of the avatar AV in the virtual space VS. The event determination unit 121 determines the specific image 28S showing the state of the level up of the avatar AV in the plurality of virtual spaces VS by recognizing characters indicating the level up of the avatar AV, such as “level up”, “LEVEL UP”, “rank up”, and “rank has gone up”, shown in the specific image 28S. The event determination unit 121 outputs a determination result 122 to the layout unit 103. The determination result 122 includes the image ID of the specific image 28S showing a state of the level up of the avatar AV in the plurality of virtual spaces VS. The layout unit 103 disposes the specific image 28S showing the state of the level up of the avatar AV in the plurality of virtual spaces VS, at adjacent positions in the photo album 52.

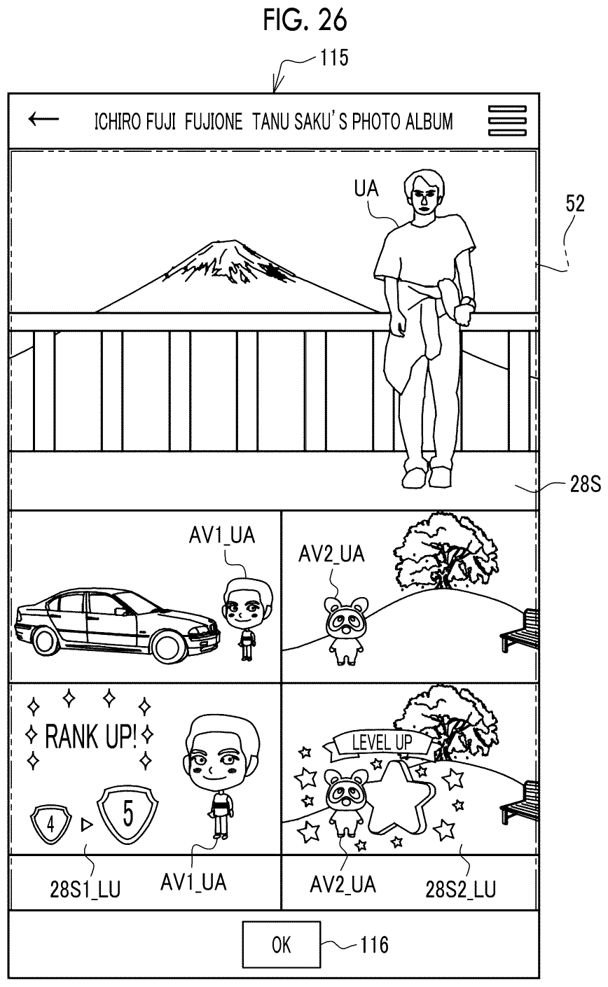

Therefore, FIG. 26 shows the photo album 52 in this case as an example. That is, the specific image 28S1_LU showing the state of the level up of the first avatar AV1_UA in the first virtual space VS1 and the specific image 28S2_LU showing the state of the level up of the second avatar AV2_UA in the second virtual space VS2 are disposed at adjacent positions.

As described above, in the second embodiment, the layout unit 103 disposes the specific images 28S showing the common event among the plurality of specific images 28S showing the plurality of virtual spaces VS, at adjacent positions in the photo album 52. Therefore, the specific images 28S showing the common event in the plurality of virtual spaces VS can be disposed at adjacent positions without bothering the hand of the user U. The photo album 52 has a sense of unity, and thus the photo album 52 can be made more attractive.

It should be noted that the event is not limited to the level up example. The event may be a case in which a companion who acts together is added, a case in which an item that is a key to game strategy is obtained, and the like. In addition, the event may be a seasonal association such as a Christmas party, a New Year's party, or the like held for each virtual space VS, or a non-seasonal association, such as a birthday party of a certain user U, an anniversary party of the virtual space VS, or a virtual culture lecture. In a case of the seasonal association, it is possible to determine the specific image 28S having the same event depending on the imaging date and time. In a case of the non-seasonal association, the specific image 28S having a common event can be determined by referring to the word or the like registered in an item of the tag of the accessory information 51. Alternatively, the specific image 28S showing the common event may be determined by using a machine learning model that outputs the event shown in the image 28 in response to the input of the image 28.

### Third Embodiment

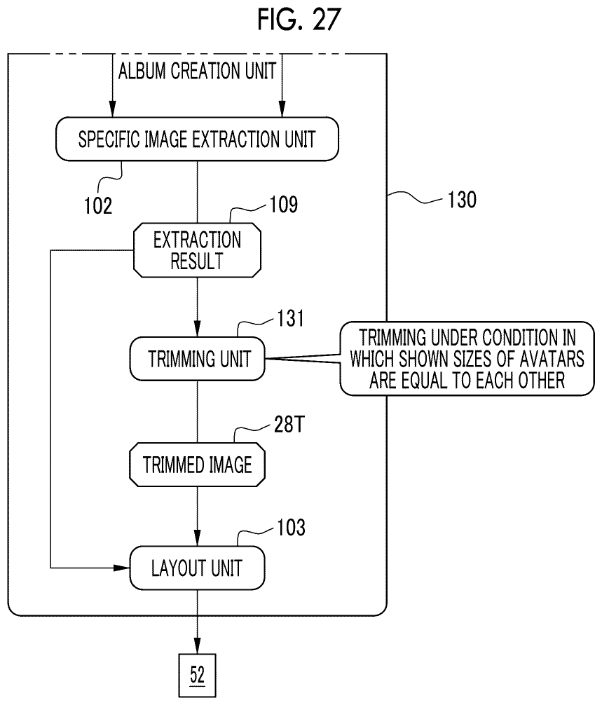

As shown in FIG. 27 as an example, an album creation unit 130 according to the third embodiment includes a trimming unit 131 in addition to the processing units 100 to 103 (the first evaluation unit 100 and the second evaluation unit 101 are not shown in FIG. 27) according to the first embodiment. The trimming unit 131 is provided between the specific image extraction unit 102 and the layout unit 103. The extraction result 109 is input from the specific image extraction unit 102 to the trimming unit 131.

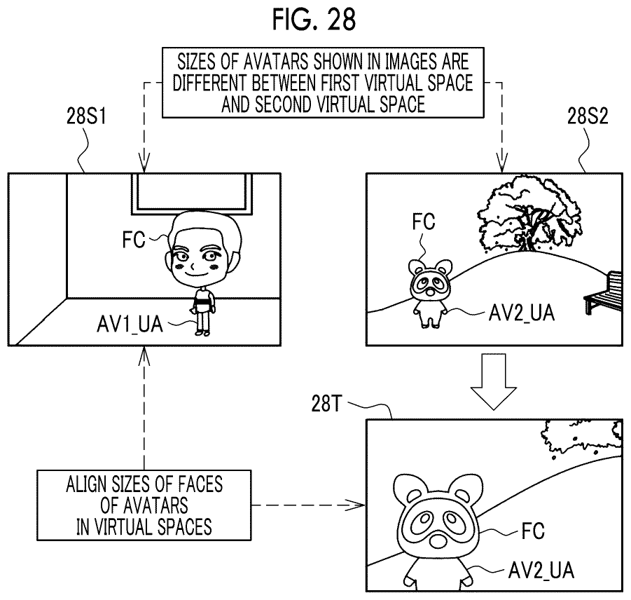

As shown in FIG. 28 as an example, in a case in which the shown sizes of the avatars AV of the plurality of virtual spaces VS are different between the plurality of specific images 28S showing the plurality of virtual spaces VS, the trimming unit 131 performs the trimming on the specific image 28S under a condition in which the shown sizes of the avatars AV of the plurality of virtual spaces VS are equal to each other. The trimming unit 131 outputs a trimmed image 28T, which is a result of the trimming, to the layout unit 103.

FIG. 28 shows a case in which, in the specific image 28S1 showing the first virtual space VS1 and the specific image 28S2 showing the second virtual space VS2, the size of the face FC of the second avatar AV2_UA is smaller than the size of the face FC of the first avatar AV1_UA, and the size of the face FC of the first avatar AV1_UA and the size of the face FC of the second avatar AV2_UA are different from each other. In this case, the trimming unit 131 performs trimming on the specific image 28S2 to generate the trimmed image 28T, and aligns the size of the face FC of the second avatar AV2_UA with the size of the face FC of the first avatar AV1_UA shown in the specific image 28S1.

As described above, in the third embodiment, in a case in which the shown sizes of the avatars AV of the plurality of virtual spaces VS are different between the plurality of specific images 28S showing the plurality of virtual spaces VS, the trimming unit 131 performs the trimming on the specific image 28S under the condition in which the shown sizes are equal to each other. Therefore, it is possible to reduce the discomfort caused by the spatial discontinuity perceived by the user U by the plurality of faces FC of the avatar AV having different appearances due to being in the plurality of different virtual spaces VS. The photo album 52 has a sense of unity, and thus the photo album 52 can be made more attractive. The trimming may be performed on the specific image 28S under a condition in which the shown size of the entire body of the avatar AV is equal to that of the avatar AV instead of the face FC of the avatar AV.

In the first embodiment, the aspect has been described in which the user U selects the representative face image 28RF for which the integrated face ID is desired to be registered on the face editing screen 80 to associate the plurality of faces FC that correspond to the same user U and that have different appearances in the plurality of spaces, but the technology of the present disclosure is not limited to this. For example, the following method may be adopted.

That is, account information of the user U used in the image management service provided by the image AP 30 and account information of the user U used in the virtual space VS are made common. The association unit 63 accesses the management server of the virtual space VS based on the common account information, to acquire the face image 28F of the avatar AV of the user U in the virtual space VS. The association unit 63 derives the face feature value ZF of the face image 28F and collates the derived face feature value ZF with the representative face feature value ZRF of the face list 53 to recognize which face ID in the face list 53 corresponds to the face FC of the avatar AV of the user U. The association unit 63 registers a new integrated face ID in the item of the integrated face ID of the face ID recognized as the face ID of the face FC of the avatar AV and the face ID of the real face FC of the user U. In this case, it is possible to automatically associate the integrated face ID with the user U without taking time and effort for the user U to select the representative face image 28RF for which the integrated face ID is desired to be registered.

The face list 53 may be generated from the images 28 designated by the user U to be used in the photo album 52, in a case of creating the photo album 52. In such a case, the face list 53 is generated each time the photo album 52 is created. Similarly, the association of the plurality of faces FC that correspond to the same user U and that have different appearances in the plurality of spaces may also be performed as a part of the designation work in a case of creating the photo album 52 each time the photo album 52 is created.

The composite image may be an image created by combining the plurality of specific images 28S as in the photo album 52 described in each of the above-described embodiments, or may be an image created by combining at least one specific image 28S and at least one template image prepared in advance. Examples of the image created by combining the plurality of specific images 28S include a collage image created by bonding the plurality of specific images 28S with different orientations and positions in a random manner. In addition, examples of the image created by combining the plurality of specific images 28S may include a shuffle print created by arranging the plurality of specific images 28S on a paper surface having a specific size such as a postcard size or an A4 size. Examples of the image created by combining at least one specific image 28S and at least one template image prepared in advance include an image created by combining one specific image 28S with an image of a date of a calendar or an image of a zodiac sign for a New Year's card.

The image management server 12 may perform all or some of the functions of the browser control unit 32 of the user terminal 10. Specifically, the image management server 12 generates various screens such as the face editing screen 80 and the album creation screen 90, and then distributes and outputs the screens to the user terminal 10 in a format of screen data for web distribution created by, for example, a markup language such as extensible markup language (XML). In this case, the browser control unit 32 of the user terminal 10 represents various screens to be displayed on the web browser based on the screen data, and displays various screens on the display 24A. Another data description language such as Javascript (registered trademark) object notation (JSON) may be used instead of the XML.

A hardware configuration of the computer constituting the image management server 12 can be modified in various ways. For example, the image management server 12 may be configured by a plurality of separate computers as hardware in order to improve processing capacity and reliability. For example, the functions of the request reception unit 45 and the editing unit 46 and the functions of the RW control unit 47 and the distribution control unit 48 are distributed to two computers. In this case, the image management server 12 is configured by two computers. In addition, all or some of the functions of the image management server 12 may be assigned to the user terminal 10.

In this way, the hardware configuration of the computers of the user terminal 10 and image management server 12 can be changed as appropriate depending on the required performance, such as processing capacity, safety, and reliability. Further, it goes without saying that, in addition to the hardware, the APs, such as the image AP 30 and the operation program 35, can also be duplicated or distributed and stored in a plurality of storages for the purpose of securing the safety and the reliability.

In each of the above-described embodiments, for example, as a hardware structure of a processing unit that executes various types of processing, such as the browser control unit 32, the request reception unit 45, the editing unit 46 (brightness adjustment unit 60, effect unit 61, face ID recognition unit 62 (face extraction unit 70, face feature value derivation unit 71, collation unit 72, and face ID write unit 73), association unit 63, album creation unit 64 (first evaluation unit 100, second evaluation unit 101, specific image extraction unit 102, layout unit 103, event determination unit 121, and trimming unit 131)), the RW control unit 47, and the distribution control unit 48, various processors shown below can be used. The various processors include, for example, the CPUs 22A and 22B which are general-purpose processors executing software (the image AP 30 and the operation program 35) to function as various processing units, a programmable logic device (PLD), such as a field programmable gate array (FPGA), which is a processor whose circuit configuration can be changed after manufacture, and/or a dedicated electric circuit, such as an application specific integrated circuit (ASIC), which is a processor having a dedicated circuit configuration designed to execute specific processing.

One processing unit may be configured by one of these various processors, or may be configured by a combination of two or more processors of the same type or different types (for example, a combination of a plurality of FPGAs and/or a combination of a CPU and an FPGA). Moreover, a plurality of processing units may be configured by one processor.

As an example in which the plurality of processing units are configured by one processor, first, as represented by a computer, such as a client and a server, there is a form in which one processor is configured by a combination of one or more CPUs and software, and the processor functions as the plurality of processing units. Second, as represented by a system on a chip (SoC) or the like, there is a form in which a processor, which implements the functions of the entire system including the plurality of processing units with a single integrated circuit (IC) chip, is used. As described above, as the hardware structure, the various processing units are configured by one or more of the various processors described above.

Further, more specifically, an electric circuit (circuitry) in which circuit elements such as semiconductor elements are combined can be used as the hardware structure of the various processors.

The technology according to the following supplementary notes can be understood based on the above description.

### Supplementary Note 1

An image processing device comprising: a processor configured to: acquire a plurality of images showing a plurality of different spaces including at least one virtual space in which an avatar of a user acts; and associate a plurality of faces that are shown in the images, that correspond to the same user, and that have different appearances in the plurality of spaces, with each other.

### Supplementary Note 2

The image processing device according to supplementary note 1, in which the plurality of spaces include a plurality of the virtual spaces, and the plurality of faces having different appearances include a face of the avatar in each of the plurality of virtual spaces.

### Supplementary Note 3

The image processing device according to supplementary note 1 or 2, in which the plurality of spaces include the virtual space and a real space, and the plurality of faces having different appearances include a face of the avatar in the virtual space and a real face of the user in the real space.

### Supplementary Note 4

The image processing device according to any one of supplementary notes 1 to 3, in which the processor is configured to: acquire a list of face identification information of which a correspondence relationship with a feature value of a face is known; and perform the association by editing the list.

### Supplementary Note 5

The image processing device according to any one of supplementary notes 1 to 4, in which the processor is configured to: acquire a list of face identification information of which a correspondence relationship with a feature value of a face is known; derive a feature value of a face of which face identification information is unknown, from the image; and recognize which face identification information in the list corresponds to the face of which the face identification information is unknown, by collating the derived feature value with the feature value in the list.

### Supplementary Note 6

The image processing device according to supplementary note 5, in which the processor is configured to: receive designation of a target user; extract a specific image including an image showing a face of the target user from among the plurality of images based on a result of the recognition; and create a composite image based on the specific image.

### Supplementary Note 7

The image processing device according to supplementary note 6, in which there are a plurality of the target users, and the specific image includes an image showing the faces of the plurality of target users together.

### Supplementary Note 8

The image processing device according to supplementary note 6 or 7, in which the processor is configured to: assign a score to each of the plurality of images; and extract the specific image based on the scores.

### Supplementary Note 9

The image processing device according to supplementary note 8, in which the processor is configured to: assign a higher score to the image showing the face of the target user than an image not showing the face of the target user.

### Supplementary Note 10

The image processing device according to any one of supplementary notes 6 to 9, in which the plurality of spaces include a plurality of the virtual spaces, and the processor is configured to: dispose images showing a common event among a plurality of the specific images showing the plurality of virtual spaces, at adjacent positions in the composite image.

### Supplementary Note 11

The image processing device according to any one of supplementary notes 6 to 10, in which the plurality of spaces include a plurality of the virtual spaces, and the processor is configured to: in a case in which shown sizes of the avatars in the plurality of virtual spaces are different between a plurality of the specific images showing the plurality of virtual spaces, perform trimming on the specific images under a condition in which the shown sizes are equal to each other.

The technology of the present disclosure can also be combined with various embodiments and/or various modification examples described above, as appropriate. In addition, it goes without saying that the present disclosure is not limited to each of the embodiments described above, various configurations can be adopted as long as the configuration does not deviate from the gist. Further, the technology of the present disclosure includes a storage medium that stores the program in a non-transitory manner, in addition to the program.

The above-described contents and the above-shown contents are the detailed description of the parts according to the technology of the present disclosure, and are merely an example of the technology of the present disclosure. For example, the above description of the configuration, the function, the operation, and the effect are the description of examples of the configuration, the function, the operation, and the effect of the parts according to the technology of the present disclosure. Accordingly, it goes without saying that unnecessary parts may be deleted, new elements may be added, or replacements may be made with respect to the above-described contents and the above-shown contents within a range that does not deviate from the gist of the technology of the present disclosure. Moreover, in order to avoid complications and facilitate grasping the parts according to the technology of the present disclosure, in the above-described contents and the above-shown contents, the description of technical general knowledge and the like that do not particularly require description for enabling the implementation of the technology of the present disclosure are omitted.

In the present specification, “A and/or B” has the same meaning as “at least one of A or B”. That is, “A and/or B” means that it may be only A, only B, or a combination of A and B. In the present specification, also in a case in which three or more matters are expressed in association by “and/or”, the same concept as “A and/or B” is applied.

All of the documents, the patent applications, and the technical standards described in the present specification are incorporated herein by reference to the same extent as in a case in which each of the documents, patent applications, and technical standards is specifically and individually described by being incorporated by reference.

What is claimed is:

1. An image processing device comprising:
a processor configured to:
acquire a plurality of images showing a plurality of different spaces including at least one virtual space in which an avatar of a user acts; and
associate a plurality of faces that are shown in the images, that correspond to the same user, and that have different appearances in the plurality of spaces, with each other.

2. The image processing device according to claim 1,
wherein the plurality of spaces include a plurality of the virtual spaces, and
the plurality of faces having different appearances include a face of the avatar in each of the plurality of virtual spaces.

3. The image processing device according to claim 1,
wherein the plurality of spaces include the virtual space and a real space, and
the plurality of faces having different appearances include a face of the avatar in the virtual space and a real face of the user in the real space.

4. The image processing device according to claim 1,
wherein the processor is configured to:
acquire a list of face identification information of which a correspondence relationship with a feature value of a face is known; and
perform the association by editing the list.

5. The image processing device according to claim 1,
wherein the processor is configured to:
acquire a list of face identification information of which a correspondence relationship with a feature value of a face is known;
derive a feature value of a face of which face identification information is unknown, from the image; and
recognize which face identification information in the list corresponds to the face of which the face identification information is unknown, by collating the derived feature value with the feature value in the list.

6. The image processing device according to claim 5,
wherein the processor is configured to:
receive designation of a target user;
extract a specific image including an image showing a face of the target user from among the plurality of images based on a result of the recognition; and
create a composite image based on the specific image.

7. The image processing device according to claim 6,
wherein there are a plurality of the target users, and
the specific image includes an image showing the faces of the plurality of target users together.

8. The image processing device according to claim 6,
wherein the processor is configured to:
assign a score to each of the plurality of images; and
extract the specific image based on the scores.

9. The image processing device according to claim 8,
wherein the processor is configured to:
assign a higher score to the image showing the face of the target user than an image not showing the face of the target user.

10. The image processing device according to claim 6,
wherein the plurality of spaces include a plurality of the virtual spaces, and
the processor is configured to:
dispose images showing a common event among a plurality of the specific images showing the plurality of virtual spaces, at adjacent positions in the composite image.

11. The image processing device according to claim 6,
wherein the plurality of spaces include a plurality of the virtual spaces, and
the processor is configured to:
in a case in which shown sizes of the avatars in the plurality of virtual spaces are different between a plurality of the specific images showing the plurality of virtual spaces, perform trimming on the specific images under a condition in which the shown sizes are equal to each other.

12. An operation method of an image processing device, the operation method comprising:
acquiring a plurality of images showing a plurality of different spaces including at least one virtual space in which an avatar of a user acts; and
associating a plurality of faces that are shown in the images, that correspond to the same user, and that have different appearances in the plurality of spaces, with each other.

13. A non-transitory computer-readable storage medium storing an operation program of an image processing device for causing a computer to execute a process comprising:
acquiring a plurality of images showing a plurality of different spaces including at least one virtual space in which an avatar of a user acts; and
associating a plurality of faces that are shown in the images, that correspond to the same user, and that have different appearances in the plurality of spaces, with each other.
